(19) United States
(12) Patent Application Publication
(10) Pub. No.: US 2017/0322722 A1
(43) Pub. Date: Nov. 9, 2017

(54) Touch Display Control Method

(71) Applicant: Nes Stewart IRVINE, Letchworth, Herfordshire (GB)

(72) Inventor: Nes Stewart IRVINE, Letchworth, Herfordshire (GB)

(21) Appl. No.: 15/531,696

(22) PCT Filed: Dec. 2, 2015
(86) PCT No.: PCT/GB2015/053690

§ 371 Date: May 30, 2017

(30) Foreign Application Priority Data
Dec. 2, 2014 (GB) 1421434.0
Jan. 14, 2015 (GB) 1500524.2
Jan. 15, 2015 (GB) 1500600.0
Jan. 15, 2015 (GB) 1500602.6
Jan. 15, 2015 (GB) 1500689.3
Jan. 16, 2015 (GB) 1500775.0
May 2, 2015 (GB) 1507608.6
May 3, 2015 (GB) 1507615.1
May 5, 2015 (GB) 1507701.9
May 8, 2015 (GB) 1507938.7
May 9, 2015 (GB) 1507942.9
May 19, 2015 (GB) 1508543.4
May 19, 2015 (GB) 1508602.8
Jun. 4, 2015 (GB) 1509731.4
Jun. 5, 2015 (GB) 1509833.8
Oct. 7, 2015 (GB) 1517758.7
Oct. 19, 2015 (GB) 1518484.9
Oct. 19, 2015 (GB) 1518490.6
Oct. 19, 2015 (GB) 1518491.4
Oct. 21, 2015 (GB) 1518610.9
Oct. 21, 2015 (GB) 1518696.8
Oct. 22, 2015 (GB) 1518772.7
Oct. 26, 2015 (GB) 1518920.2
Oct. 30, 2015 (GB) 1519278.4
Nov. 2, 2015 (GB) 1519371.7
Nov. 4, 2015 (GB) 1519507.6
Nov. 5, 2015 (GB) 1519595.1
Nov. 18, 2015 (GB) 1520282.3
Nov. 18, 2015 (GB) 1520360.7
Nov. 23, 2015 (GB) 1520667.5
Nov. 30, 2015 (GB) 1521115.4
Nov. 30, 2015 (GB) 1521124.6

(51) Int. Cl. G06F 3/0488; H04W 12/08; G06F 3/0482

(52) U.S. Cl. CPC G06F 3/04883; G06F 3/0482; H04W 12/08

(57) ABSTRACT

If skilled people saw FIG. 1A, they would say it was a touch device (iTouch) in prior art sleep mode, which meant nothing could happen if you touched the screen, and saves power by a turned off touch-sensitive screen. They would be completely wrong, as it shows an i Touch operating by independent touch IT e.g. a user can unlock and turn on the display by performing the swipe 2 (FIG. 1A) independent to a turned off display screen without pressing the button 1, which is impossible for the prior art. IT's unknown beneficial superior properties are an instant, simplest, easier to use, more reliable, pressure independent, more power conserving operation, with less digit movement, and safer overall, with an aesthetic beauty requiring no ugly external buttons, improving the user's mental recall and decisiveness; and has beauty, ergonomic simplicity, and increased capacity, improving any performance of an operation or task in the prior art.

PRIORITY DOCUMENTS

From the 2 Dec. 2014 there have been numerous priority documents, which although filed in draft format and may have unintentional errors, may be useful as background for statements that support the claims of this invention as it has be a considerable challenge to confine the description of this new invention to the 30 pages of a PCT document. Thus this document provides a very brief description of a few representative embodiments to illustrate the scope of the attached claims of the invention and why it cannot be anticipated by the prior art.

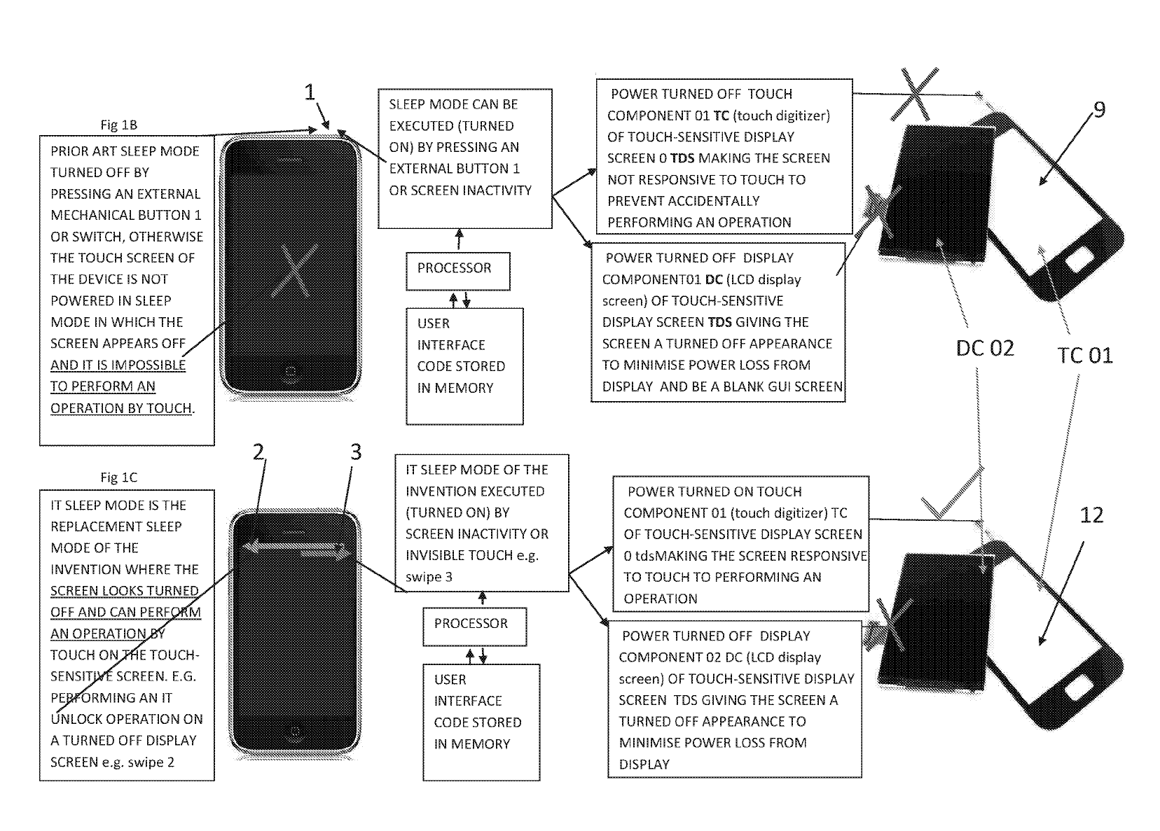

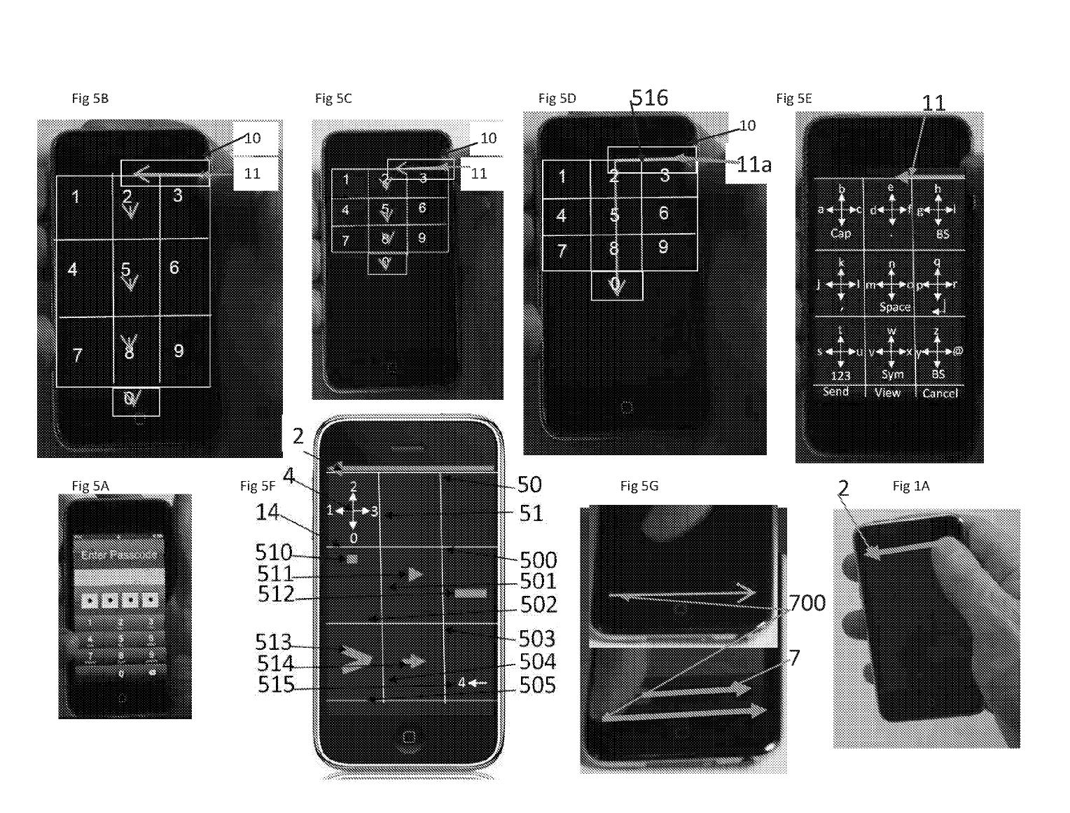

The priority documents shown serial photographs in the drawing pages of GB1520360.7 and GB 1520667.5 of how the swipe 700 is performed by a digit in pages 181 to 285 and how the touch operation 142 is different from the prior art method of pages 27 to 159 illustrating the normal iPhone unlock illustrating the FIG. 13 touch GUI. Indeed to illustrate FIG. 5G we see how swipe 700 by serial photographs in pages 181 to 285 of swipe 700 would have required less programming skill than swipe 7 of FIG. 5G illustrated in pages 369-429. Indeed in GB 1520667.5, the above is illustrated by serial photographs in the identical drawing page numbers except the drawings are marked by a Fig. e.g. swipe 700 is shown by FIG. 181 to FIG. 285 etc. This document also illustrates the swipe 2 by serial photographs from FIGS. 427 to 451. Then the global swipe 3 which turns off the display component DC of the touch-sensitive display screen TDS on every GUI 134 screen from the same position (overriding any prior art programming) and locks the device is shown by FIGS. 453 to 496 until swipe 2 is repeated. FIG. 5A (the conventional manner of entering a password is shown by serial photographs from FIGS. 499 to 567. FIG. 5C is shown by serial photographs entering a password by IT on a blank number pad from FIGS. 570 to 628. FIG. 5D is shown by serial photographs performing a touch of a right angled swipe to enter the password 2580 from FIGS. 631 to 658 and a serial photograph using number pad using three regions with 4 swipes per region as shown in FIGS. 659 to 757 (FIG. 1A in the earlier priority documents). This shows how easily and reliably a number pad could enter numbers on a blank screen faster than the prior art, without any button press or the TDS is turned on or a GUI to touch as was essential in the prior art. Indeed serial photographs of FIGS. 761 to 866 shows how someone could text on an invisible keyboard to enter any command into a command-line prompt to perform any operation of the device now or in the future by entering a text command, or could text without requiring any visual feedback on the screen which may become the latest craze in 20 years as a sign of intelligence or employability as it requires a person to visualise the text without seeing it. Thus by viewing these serial photographs the method of operation of FIG. 1A to FIG. 5E should be self evident.

### PRIOR ART

This invention is a new touch interface where the user can just touch the touch-sensitive screen and perform a touch operation whether the display screen is turned on or off at any time while the device is powered. This was impossible for the CLI, GUI or the touch GUI of the U.S. Pat. No. 8,549,443 which is the prescient patent method for all modern touch devices like the iPhone, because all required as essential at least the display to be on for the user to see what they were typing in the CLI or to show a GDE (graphical display element) in the GUI resistive touch screen which reserved touch to position a digit so it was designed never to perform an operation by touch and a press to click or perform an operation, or a touch GDE of the '443 patent which could touch the GDE instead of pressing them on a mobile device touch screen to perform the operation required as essential a GDE e.g. control area 1 to be displayed on a GUI capacitive touch LCD screen which the user could see to touch. Thus although the '443 patent is the nearest patent, all these above interfaces required at least something to be displayed on a screen in order to perform an operation. Thus there is no prior art that suggested on a blank turned off appearance of a TDS in sleep mode which was the universal screen appearance of the GUI blank screen indicating that nothing could happen by touch and the device was safe to put in a pocket. Thus touch on a TDS independent of a blank screen and a button press and a GUI displayed on the screen to determine the touch operation was unknown.

### INVENTION

This invention is the invention of a completely new touch interface. Its scope is so broad it needs numerous method claims to capture its scope of the unifying inventive concept of independent touch as shown in the flow diagram of FIG. 14. However, the invention is very simple, as illustrated by one of the independent method claims.
Claim 24. A method of performing an operation of a device by a path of one or more locations touched by a movement of a digit on a touch-sensitive display screen as the only input method on the surface of the device.

This invention is the invention of independent touch performing a touch operation 142 on a TDS independent to being turned on or off or any external button press or a duration of the digit movement as the only essential input method needed to perform an operation on the surface of the device while the device is powered is completely unknown, and all its superior unexpected properties over the GUI or touch GUI are unknown because everyone has believed that the essential steps of a GUI in FIG. 13 were essential to input touch into a GUI. Independent touch needed only the location information of one or more locations touched to perform an operation, as a turned off display screen provided all the visual feedback necessary to perform operations without requiring the limiting steps of 131 to 135 of the touch GUI. The only reason the invention of IT is unknown and all its superior properties among the skilled person SP is that it require a flash of inspiration of doing something completely different, as it requires much less programming skill to perform a touch operation 141 using independent touch of FIG. 14 of only a touch component TC on 141 rather than the conventional touch GUI of the '443 patent which required both the TC and the DC to be on 133, indeed the invention could have been implemented by any averagely skilled person who had the skill to program in iOS, Android or Windows Phone or any other touch GUI of FIG. 13 within a day of having thought of the invention and its unknown superior properties over the prior art touch GUI.

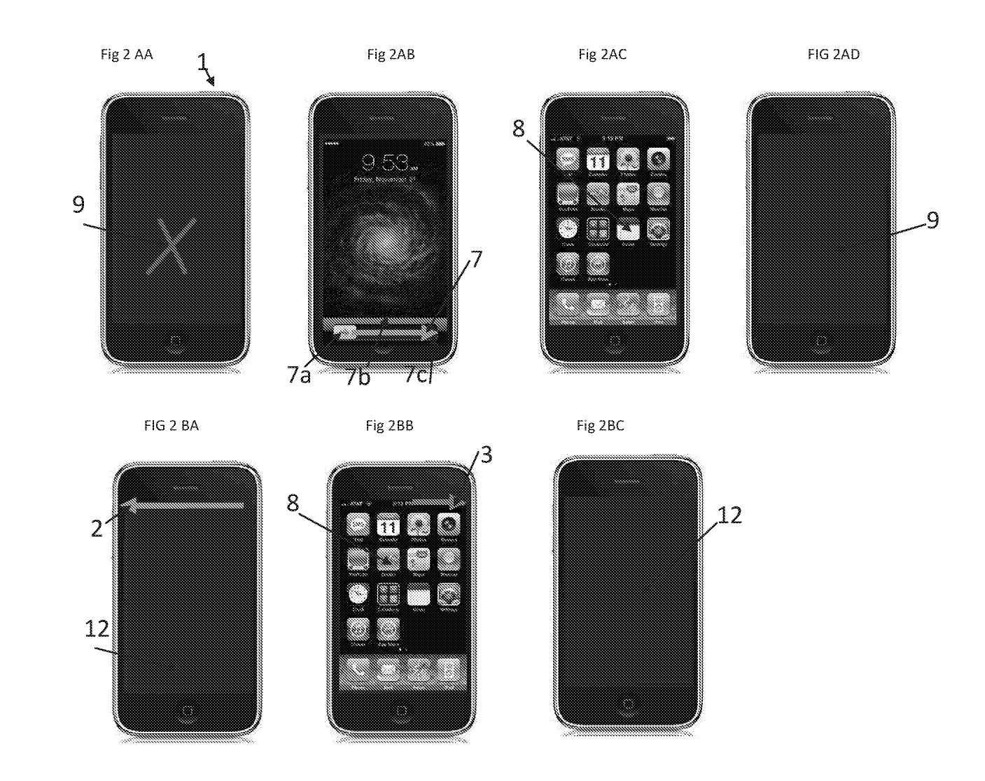

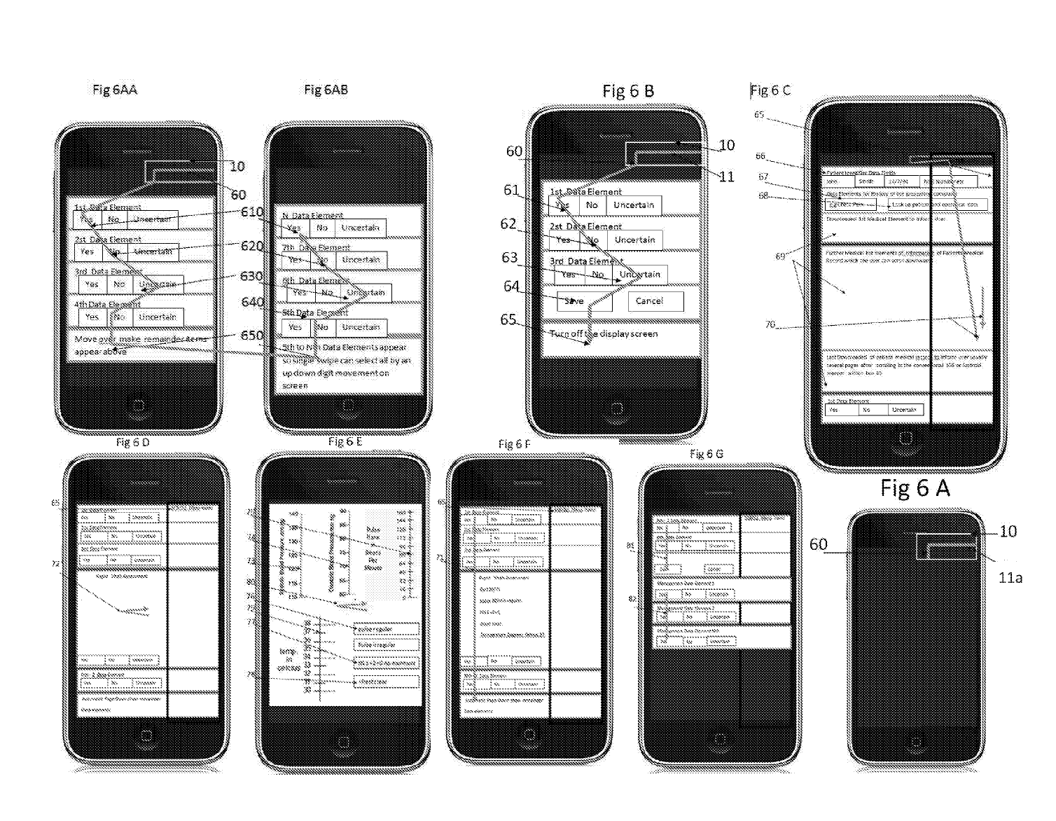

Indeed, a skilled person seeing FIG. 1 A and FIG. 5G and FIG. 2BA-2BC would immediately appreciate the following superior properties of independent touch over the touch GUI 134 of FIG. 2AA-2AD: 1) Always on (the user can always touch the surface and instantly operate the swipe 700 at any time when the TDS is turned off in the prior art). 2) Instant (there is no delay or fumbling to find a button the user just touches the screen, and no wasted time from pressing the button to then waiting for the screen to be displayed and then seeing the slider and then touching the slider). 3) Simpler (a swipe 700 is simpler than a button press and a swipe 7). 4) Faster (a two step process of a button press and essentially performing an identical swipe 7 to swipe 700 is always going to be slower than just performing swipe 700 of the invention). 5) Flexible (the user could change only one operation according to the independent touch operation 142 of claim 1 e.g. swipe 2 in addition to all the prior art touch operations 136, to changing as many of the prior art touch operations 136 to be operated differently by the touch operation 142 of the invention. Thus this gives maximum flexibility of a new interface being able to alter one operation to all operations from the prior art operation 136 to the independent touch operation 142 or independent touch 142 or IT 142.). 6) Familiar as swipe 700 is almost identical to swipe 7 but on a blank screen. 7) Easy to learn as swipe 2 or swipe 700 is similar to the swipe 7. 8) Independent touch has the capacity to create dependent touch GUI operations to override the existing GUI operation e.g swipe 3. 9) Accessibility (the user can access all operations from a blank screen using a command line prompt as shown in FIG. 5E). 10) Fastest Passport access (There is not a quicker or easier way of entering a password reliably, and with better safety than a button press 1 and a swipe 7, and with power conservation of not having the DC turned on as shown in FIG. 5D. Indeed, this is faster, and more instant than fingerprint recognition, which is not safe as the mugger may just press the user finger on the button, which is easier to do then find a 1 in 10000 password, which if tried a couple of times with error can be arranged to get the user to repeat the password 2× or 3× in order to unlock the device). 11) More reliable (the prior art method requires three components to work a button, a display component DC and a touch component TC, thus there are three parts to go wrong compared with just the TC of the invention. Furthermore because the user does not have to waste time pressing a button and moving a digit from button 1 to the slider 7a in FIG. 2AB, the swipe 700 may be made slightly longer which means the probability of the device being accidentally triggered especially in the hands of the child will be statistically less as there are no visual clues for the child. 12) Cheaper (even though buttons are cheap, the circuitry and provision of a button are extra complication and expense than producing a device without any external buttons because they are obsolete in the method of FIG. 14 but essential in the method of FIG. 13). 13) Less effort (it is less effort to not press a button 1 and not have to move to a slider, by just performing swipe 700 on the turned off display screen in the FIG. 14 method, which is almost identical to swipe 7.). 14) Less digit movement therefore more efficient (the digit movement to the button 1 and then to the slider 7a is additional to the swipe 7 or swipe 700). 15) Designed to be good for one digit touch of a thumb e.g. right alone in a right hand. (the user can perform the swipe 2 or swipe 3 in FIG. 1 A, FIG. 1C, or FIG. 2BB much easier than a button 1 press and then a swipe 7). 16) Better power conservation during performing the operation because the DC of the TDS is turned off during the swipe. 17) Prolonged instant usage throughout the whole battery life as the TC is always on. 18) Increased capacity as can perform all touch operations of prior art device with the display on and touches with the display off. 19) Better aesthetic or different aesthetic appearance of the device if it contains one operation performed by IT. 20) Fastest user interface to perform an operation e.g. swipe 700 rather than button press 1 and swipe 7. 21) Fastest user interface to perform a task. A task is a sequence of operation that need to be completed to perform the task, and the operation of claim 1 can be a task e.g. performing the task in FIGS. 6AA and 6AB by a single swipe. 22) No contamination of the device through cracks in the surface and using sealed plastic bags to cover old iPads to prevent cross contamination. 23) The invention as a whole is vastly superior as all the diagrams explain especially comparing FIG. 13 to FIG. 14. 24) Able to improve the operation of any prior art operation by touch. 25) Backward compatibility able to perform all operations of the prior art (e.g. swipe 2 is an independent touch but it accesses all the prior art operations of the touch GUI).

### BRIEF DESCRIPTION OF THE DIAGRAMS

FIG. 1 and FIG. 2 This shows how a user may remove the need for an on off button on the surface of the device and thereby allow a user to have a touch device which responds all the time to touch to perform operations instead of any operations being performed by any other input like any button on the surface of the device, and since touch can control devices wirelessly, and charging the battery can be done by induction, the outside of the new touch device can now be totally smooth and sealed with the potential of a much better aesthetic appearance, which was an impossibility for any device which had a sleep mode.

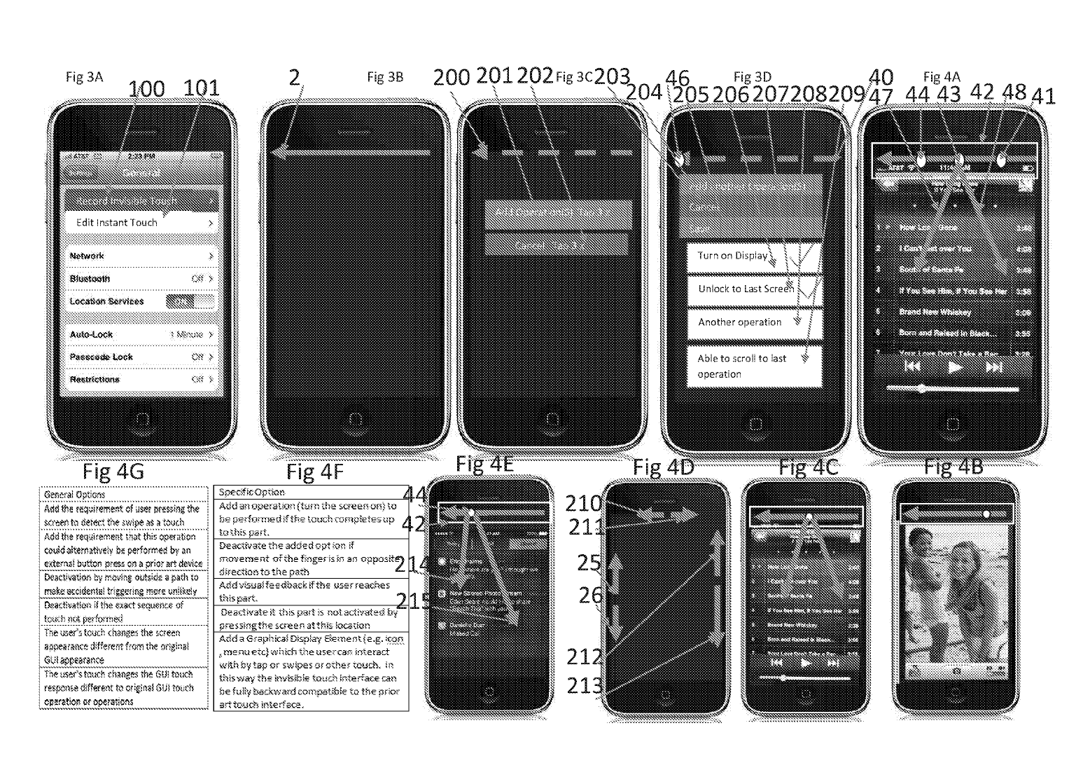

Furthermore FIG. 3 and FIG. 4 allowed the user to perform their own touches and select one or more operations of the device to be performed by the touch, and FIG. 4 allowed the user to have another program which could enable a user to add one or more further operations to be performed at one or more locations on the path of a touch of a digit by one or more further touches.

FIG. 5 shows how the user by a series of swipes could enter a number and that number could perform a unique operation of the device, and by this method the operation may be all operations of the device performable by a touch of a series of swipes or taps on an invisible keypad or invisible keyboard (FIG. 5E) in the same way that the command-line interface can operate all operations by typing in lines of code. Thus the touch of claim 1 can be one or more touches of one or more digits on a screen, and the operation can be one or more operations of the device for one or more locations touched of a touch (e.g. a swipe), all entered by touch or a series of touches on an invisible number pad or keyboard.

Furthermore FIG. 6 shows how this touch could perform the operation of a task e.g. a single swipe could operate a sequence of operations needed to complete a task, and showed one way how a task could be completed without error in a single swipe e.g. FIG. 6 AA-6 AB.

FIG. 7 shows how an attached stylus to a digit may never be lost and makes writing and prior art pointing device easy by touch.

FIG. 8 then explained how the power drainage of having the TC continually minimised could be reduced, and even made better than a mechanical button in sleep mode by having solar power cells on the surface of the TC to provide more energy than the small area of 802 which needed to be continually powered. And by realising that the TC of the TDS could perform all the operations of an external button on a device, made obvious that an internal button was less likely to be damaged in a car crash when a TC of a TDS was most likely to be damaged, and that having an internal button or switch by the battery would be useful to reset the device, completely power off the device, or send a GPS coordinate to an emergency service and thereby may save a life. Furthermore other methods like using solar power cells as a backup method to detect touch by light and other special touches could be designed on the TC of the TDS so even if the screen was damaged and could not be displayed the user would have operations performable by invisible touch which could reset the device if the accident had caused the software to freeze, by a separate independent circuit of touch or solar power to the software driving the rest of the computer operations.

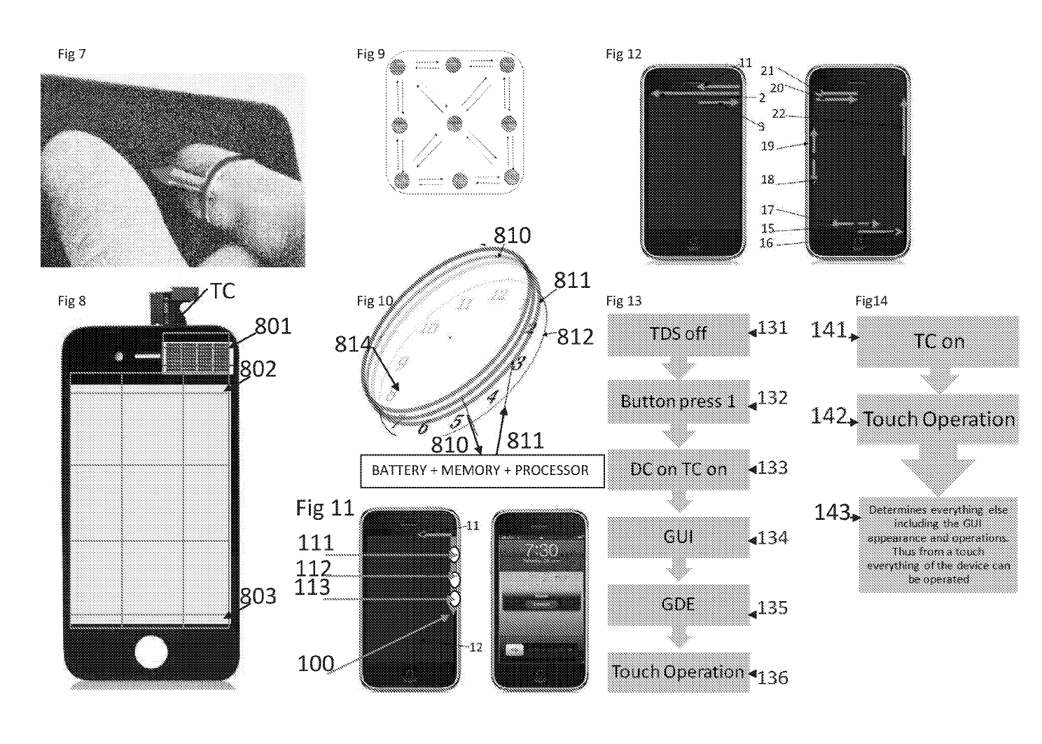

Furthermore, the possibilities of touch to perform a operation are virtually unlimited and FIG. 9 shows another set of touches and taps at the circles of a touch-sensitive screen shown in FIG. 9 and also swipes or slides between these circles all as other ways of executing operations on a blank screen, even the miniaturised blank screen of a iWatch or equivalent. Furthermore the ability of touch to be performed on crystal glass (like the iWatch) means that the crystal of the analog Swiss watch as an example may detect an input of invisible touch to perform an operation without any visual feedback or it could be connected to a transparent LCD screen which allows the user to see the analog watch, but could show text downloaded from a phone when the display screen was touched in a specified manner to perform that operation.

Indeed all the FIG. 1-10 are a very limited selection of possible embodiments of the invention limited by the claim language of this invention.

FIG. 11 shows how silent mode can be instantly done by any touch on the touch-sensitive screen when the phone is ringing, and the user then can take the phone out at their leisure and then perform a swipe 11 to see the notification that had caused the phone not to be silent and this may be terminated in the normal way.

FIG. 12 shows how a user may design their own operations all dependent on a swipe 11 making accessible a range of different invisible touch operations instead of the device requiring any external buttons.

FIG. 13 shows a flow diagram why the nearest prior art touch GUI cannot anticipate the

FIG. 14 independent touch flow diagram.

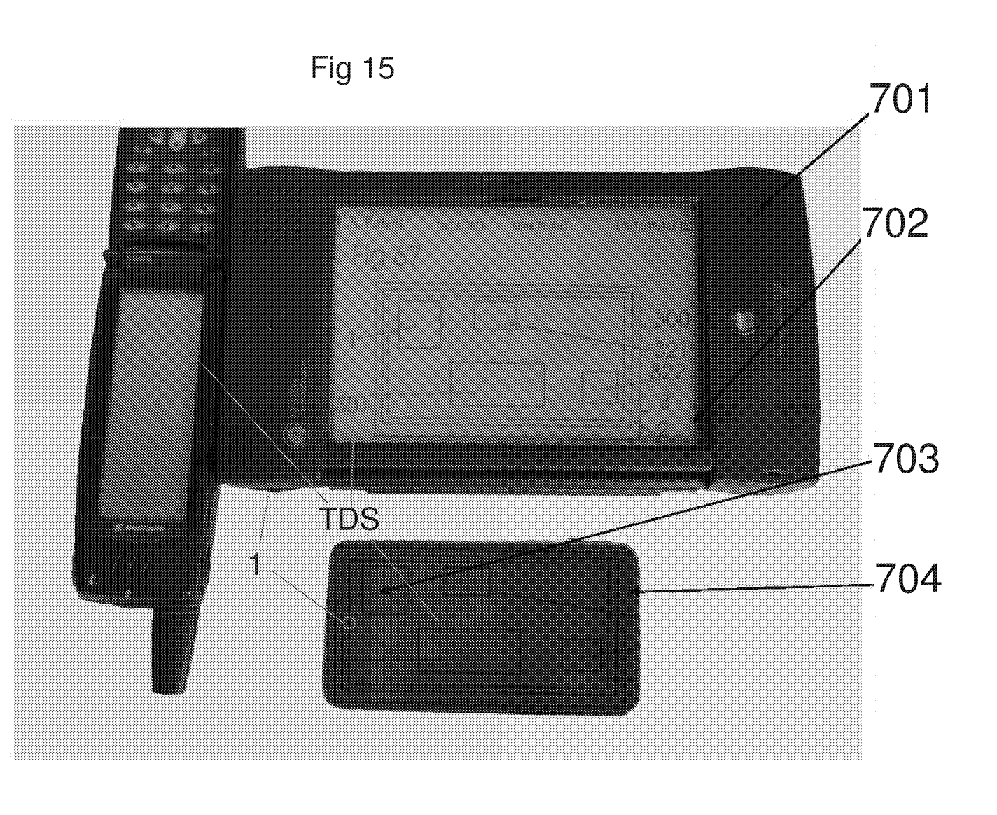

FIG. 15 shows the prior art device has a TDS with an external button 1 and requires the screen to be turned on to display a GUI in order for touch to work, whereas FIG. 14 performs an operation by touch on the TC of the TDS as the only input method.

### DETAILED DESCRIPTION OF THE DIAGRAMS

### FIG. 1A

This shows one embodiment of the invention. It shows a thumb performing a swipe 2 on a prior art touch device which has been modified according to the invention by having a TC turned on 141 and it performs a touch operation 142 of turning on the display screen and showing the last screen accessed with all the benefits as described in the abstract over the prior art device button press 1 and swipe 7.

### FIG. 1B

This illustrates the prior art touch device structure in sleep mode which made sure that the TDS had both a turned off touch component TC 01 and a turned off display component DC 02 as shown by a display screen 9. Thus this prior art touch device configuration used by the entire prior art touch software enabled it to be impossible for the TDS to detect touch or to use power as the TDS was turned off, unless a button 1 was pressed.

### FIG. 1C

This illustrates the touch device configuration of the invention which made sure that the TDS had both a turned on 12 touch component TC 01 and a turned off display component DC 02 as shown by a display screen 12. The importance is from a visual perspective screen 12 shown in FIG. 2BC of the invention looks identical to screen 9 in FIG. 2AD which had the GUI appearance of a switched off TDS in sleep mode, which for 20 years symbolised the display screen was safe to touch and incapable of performing an operation by touch. However, this touch device configuration enables the user to perform an operation at any time while the device is powered without any limitations of the prior art in FIG. 13 of 131-135, which made it impossible for the prior art touch device to perform a touch operation 142 in the prior art GUI or touch GUI 134.

### FIG. 2AA

This emphasises that the prior art touch device screen in sleep mode could not perform any operation on the turned off TDS 131 illustrated by the visual feedback of TDS with screen appearance 9 and screen completely inoperable to touch. In order to power both the TC and DC component of the TDS so the user could see a GUI on the display screen 9, the user had to press button 1 132 to turn on the TDS screen 133 including both the TC and the DC of the TDS.

### FIG. 2AB.

This shows the display screen TDS turned on 133 showing a GUI 134 screen with a GDE 135 slider 7a and another GDE 135 slider control which has the boundary 7b, which if the user touches the GDE 135 Slider 7a and performs the swipe 7 by moving the vertical right slider edge 7a to the edge 7c and remove a digit to perform the swipe 7 this unlocks the phone to allow access of the rest of the touch operations 136 of the phone. This is equivalent to the start sequence of the nearest prior art '443 and also operating according to the independent claims of the '443 patient which was the first to describe the GUI touch interface. The important aspect of this prior art touch device operation is that it was not any touch that could perform any operation which is the scope of the touch operation 142 of the invention. This touch operation 136 was completely dependent on steps 131-135 and it was inoperative. Furthermore the user had no choice to perform any touch they liked to operate any operation on the GUI screen to modify the touch operation of unlock to operate according to the user's touch or the user's choice of operation the touch could operate. The touch GUI always operated by touch according to how the programmer had programmed the GUI. Indeed without steps 131-135 the touch was inoperative.

### FIG. 2AC

This shows the last screen seen by the user of the prior art device which was the desktop 8. After a period of screen inactivity the TDS turns off both the TC and DC so the screen is in sleep mode and is incapable of performing an operation by touch and is conserving battery power. The GUI 134 desktop 8 also is configured to detect button input. The home button could change the last screen to the desktop 8 if that was the home screen, and the on off button 1 could also turn off the to a turned off TDS 131 in sleep mode. Thus this illustrates that the device is not operating anything by touch as the only method. It is not a touch device operating by the only method of touch on a TDS 142. The principle method of control is the GUI, or what you see is what you get. Thus if you see the desktop a user knows you could turn the appearance of the GUI off by the on off button and make the display screen only to turn on by pressing the on off button 1 132 or the home button 132. Thus this representative prior art device could not perform one operation by touch on the touch-sensitive screen but was reliant on all the other input methods and configuration of 131 to 135.

### FIG. 2AD

This shows the blank TDS screen 9 of a turned off TDS which would be known and designed to be impossible to perform any operation by touch and completely safe to touch. This was the standard appearance of a blank turned off screen since 1992.

### FIG. 2BA

This shows the swipe 2 performing an operation to replace the button 1 or provide an alternative method to turn on the display screen by touch alone on the turned off DC of the TDS but turned on TC of the TDS 141 which has a screen appearance 12 identical to the TDS turned off 131 screen appearance 9 on sheet 2. Furthermore the skilled person SP would note that swipe 2 is longer than swipe 7 meaning the swipe 2 is safer than the unlock swipe 7 because it requires a longer distance of locations touched to enable the swipe 2 to be performed. Thus this is safer at unlocking the device. Furthermore it will be noted that the starting position of the swipe 2 is conveniently located for an easier right thumb swipe than the more awkward swipe 7 of the prior art. It is also safer and uses less power because the DC is turned off all the way through the swipe 2 rather than having to be on for the swipe 7, and the swipe 2 can be done quicker and easier than performing the operation by pressing a button 1 and swipe 7 of the prior art. It is a touch operation 142 of the invention of claim 1, which a user can touch a TC of a TDS 141 and perform a touch operation 142, that is a touch of a predetermined movement of one or more digits on the TC of a TDS to perform the operation. It has all the superior properties of the independent touch of FIG. 14 over the prior art FIG. 13, including at least the improved performance described in claim 11.

### FIG. 2BB

This shows the last screen shown by the user. It will be noted this is showing the last screen of the prior art touch device, and all the operations unlocked in the desktop 8 shown can be operated in the normal touch GUI manner of the prior art device software and the prior art touch device. Thus the invention of independent touch may only change one operation to be performed in the new manner of swipe 2, and all the rest of the prior art touch device can operate exactly as before to unlock the device and have all the normal behaviour of every unlocked operation of the device. However, to replace the on off button 1 completely FIG. 2BB shows a swipe 3 which will replace or provide an alternative method from every screen to turn off the DC of the TDS and to lock the screen until the swipe 2 is performed again. The swipe 3 is a good example of how when the display is on that the touch operation 142 is independent of how the prior art software programmed their original software, and may OVERRIDE or replace modifying the prior art touch response of the GUI screen. Thus no matter what programming was on the GUI screen the swipe 3 on every displayed screen will perform the operation to turn off the DC and lock the device until the swipe 2 is performed.

### FIG. 2BC

This shows a screen with a display screen permanently turned on to touch 12 but with the display screen turned off to save power. Thus the user can always operate the device by touch as long as the memory of the device is powered. Thus it provides touch always active or on to the user, but touch which is safe in that it requires swipe 2 before it can unlock the device or waste power turning the display screen on. Thus the touch is instant (always on), invisible (does not need a display screen on but only one or more locations touched), and independent (it can operate independent of any GUI appearance of the screen or previous GUI programming to touch) to perform the operation. In every aspect it is superior to the prior art dependent touch described in FIG. 13.

### FIG. 3A

This shows a general setting menu which has a menu item 100 to allow a user to record an invisible Touch or independent touch. This is one embodiment of a setting menu option to record a touch operation 142 of the invention.

### FIG. 3B

This shows an aspect of the invention where the user can record a touch operation 142. This shows the user touching the screen by a swipe 2 and the locations touched of swipe 2 is saved to memory of the device as the touch component of the touch operation 142.

### FIG. 3C

FIG. 3C shows a swipe 2 having been completed as the touch component of the touch operation 142 and represented graphically 200 on the screen. The user has an option if happy with the swipe 200 graphically represented to tap a button 201 3× to add an operation to the graphical representation of the touch. Alternatively can tap 3× on the cancel button to return to the FIG. 3A menu. Thus the button 201 provides one embodiment how the user can determine the operation component of the touch operation 142.

### FIG. 3D

Having tapped button 201 3×, FIG. 3D appears and allows the user to add an operation as the operation component of the touch operation 142 of the touch swipe 2. Thus the user can touch a location on the graphical swipe 200, e.g. location 46 at the tip of the graphical swipe 200 representing the location where the digit is removed from the screen. The user is then presented with one or more operation of a scrollable menu which could be all the operations of the device arranged in a single menu format or in hierarchical format, or alternatively there may be a magnifier icon which allows the user by a QWERTY keyboard to search for operations. Thus if we use the single menu, it can be appreciated by a long scrollable menu the user could select one or more operations out of all operations of the device e.g. the operation to turn on the display screen 206 and to unlock the last screen 207 out of a scrollable menu of 206,207,208,209. The user then could either save this 205, cancel 204, or add another operation 204 which could be used to add the additional locations 41 for the camera application, 43 for the music application, and 44 for the notification applications each which are operated by the user performing the swipe 2 and when the digit arrives at location 41, 43 or 44 shown in FIG. 4A respectively the camera application, music application, and notification application open and are displayed for the location of the circle and then disappear until the end of the swipe 2 where at 46 when the digit is removed the display is turned on and the last screen is displayed. Thus by this method of adding one or more operations 204 to the touch operation 142, this description explains how a task of operations can be performed by a single swipe 2 in FIG. 4A, or the touch operation 142 can be just the operation at 46 of swipe 2 which was shown in FIG. 3D.

### FIG. 4A

This shows the swipe 2 which had the added operations of 41, 43 and 44 described in FIG. 3. It is easy to see by the explanation of FIG. 3D, how numerous additional operations could be added by the example embodiment of FIG. 3D or another embodiment to record a touch operation 142 where the operation 142 can be an operation FIG. 3D 46 or a task of 41, 43,44, and 46 e.g. the swipe which can operate a task of a sequence of operations by a single swipe as shown in FIG. 4A and described as been creatable by FIG. 3D. In addition an editor menu item 101 in sheet 3 could also provide a means of adding locations to add operations and/or touches.

### FIG. 4B

As discussed if the user performed the swipe 2 and arrived at 41 this may open and display a prior art camera application. If the user lifted off at 41 while this application was displayed then he could access and use the camera application in the prior art manner. The user could then perform swipe 3 (not shown) to exit from this application. Because this application is accessed before the phone is unlocked no other application will be accessible, and this is made accessible with such a short swipe where the digit lifts off or is removed at 41 to access the camera in this simple embodiment.

Thus if this is done the user would cause the camera screen shown in FIG. 4B to be permanently operable and this could operate in the normal manner but no other operation could be accessed from the locked phone, but it would rapidly allow a user to take a picture or record a video using the conventional GDE programming of the prior art, with the only exception when the user had finished taking the picture, the DC of the TDS would turn off after a period of screen inactivity or the user could switch this camera application off by a swipe 3 (not shown but available in FIG. 4B).

### FIG. 4C

Likewise if the user starts the swipe 2 and continues the swipe to the location 43 the music player appears. If the user removes his finger at this point the music player can perform operations as in the prior art. The music player in FIG. 4C is shown larger in FIG. 4A so to illustrate that the user can design additional touch operations 142, which can change the normal GUI operation of the music player from how it was originally programmed by independent touch because user defined touches can override the previously programmed touch operation 136. Thus the menu may be designed by setting menu options and editor programs easy to enable in the prior art whereby the user can access the menu player screen shown in FIG. 4A and FIG. 4C and change the menu operations so that a swipe 47 movement from 43 on the left side could play song 3, but on the right side of the menu (like the black region demonstrating area 65 in FIG. 6 C) the swipe could cause a reverse scroll, this is when the user swipes 48 downwards or slides downwards and the remainder menu items not displayed e.g. songs 8-14 move upwards and are scrolled into the visible song menu item area. This independent touch is deliberately chosen because it is counter intuitive, to illustrate it is not WYSIWYG but rather the touch of WYTIWYG controlling a prior art touch GUI application, and also it is more ergonomic at seeing a few more remaining song tracts than conventional scrolling. The purpose of this additional description of 47 and 48 is showing how these independent touches of FIG. 14 can also change the touch behaviour of an open application of a prior art music player programmed with different touches. Thus this illustrates how new touches with new operations can modify the original prior art music application. FIG. 4C.

### FIG. 4D.

Furthermore, if song 3 was selected by swipe 47 and the user removed the digit, the display screen may be programmed to turn off and show the blank screen of FIG. 46 with the following operations. Swipes 25,26,210,211,212,213, respectively invisibly increase volume, decrease volume, move to the preceding tract just played to be played, move to the next tract to be played, or allows the user to scroll a previous playlist keeping the display screen only on (to show the playlists) during the slide and the selection being made by the removal (of the digit to select the selected playlist when the digit is removed), or scroll to a next playlist keeping the display screen only on during the slide and the selection being made by the removal. In addition in the MUE the user could touch to pause and play the song. Thus this brief description shown in FIG. 4D shows how numerous operations dependent on the music player being open can all be performed on an turned off screen even though the original application never was designed to have these independent touches. Thus not only can independent touches modify the behaviour and the appearance of a GUI 134 screen of prior art applications or a GDE 135 touch operation, for only the scope of a single application or single GDE, but also touches on a turned off screen can be dependent to these prior art GUI touch applications.

### FIG. 4E

This shows another very useful operation to see the latest notifications the phone has received. The user performs the swipe 2 until arriving at location 44 at which point the notifications screen appears. The user then could just look at the notification and then swipe upwards past the 42 boundary to deactivate swipe 2, or to carry on with swipe 2 and this will turn off the notification screen thus it will only appear for the briefest time for the user to see the information and exit from the notification screen, alternatively the user could perform swipe 214 to select the picture notification to see the picture or could reverse scroll the rest of the additional notifications not shown on the screen by swipe 215. Thus again the touch operation 142 may replace the prior art touch operations 136.

### FIG. 4F

This shows a small selection of specific options that a user may use when creating a touch operation 142 at a specific location as illustrated in FIG. 3 D and FIGS. 4 A-E (e.g. 46, or 41).

### FIG. 4G

This shows a small selection of general options that a user may use when creating a touch operation 142.

### FIG. 5 A-E

FIG. 5 A shows the prior art. FIG. 5A-5D. This shows how a sequence of swipes can input numbers into the touch device, and FIG. 5E shows how a sequence of swipes can enter character input into a touch device.

### FIG. 5A

This shows the prior art method. The user press button 1 to turn on the unlock screen then swipes 7 and then enters four digits e.g. 2580 to enter a password on the password screen shown in FIG. 5A.

### FIG. 5B

This shows the new independent touch method. The user performs swipe 10 by starting the swipe at the URC and lifting off the digit at the MUE within region 11. The user has divided the display screen 12 into nine invisible regions 1-9. Region 1 or an upper left region ULR or area 14, an upper middle region UMR or area 50, an upper right region URR or area 51, middle left region MLR or area 502, a middle middle region MMR or area 501, a lower right region MRR or area 500, a lower left region LLR or area 505, a lower middle region LMR or area 504, a lower right region LRR 503 as shown in FIG. 5F but represented respectively as region 1 to 9 respectively in FIG. 5B. It also shows that there is another region, region 0 represented by the rectangle enclosing the 0 over the middle lower edge MLE. In short, these regions are regions in the user's imagination representing an area of a blank turned off display screen and the areas 14, 50,51, 502,501,500,505,504, and 503 are the invisible screen areas shown on FIG. 5F corresponding to the regions 1,2,3,4,5,6, 7,8,9 in FIG. 5B.

In order to perform the equivalent password entry for the prior art, the user taps within the blank imaginary regions 2,5,8 and 0, and this inputs the identical password shown in 5A and then this performs the operation of turning on the DC of the TDS showing the desktop 8.

It would be appreciated that even this method is far more efficient at digit movement on the screen than the prior art method of FIG. 5A.

FIG. 5C This shows the identical imaginary blank regions 1-9 and 0 except the regions 1-9 fit into the upper half of the display screen 12. The user inputs the password to turn on the DC and show the last screen (e.g. Desktop 8) by the identical method in FIG. 5B. The only difference is the user has made the imaginary regions only occupy half the screen. Again in setting menu the user could adjust the number or size of the invisible regions on the blank screen, and exactly where each region is placed as an area of the screen so that the user finds an ideal region size for each number of this invisible region 1-9, and 0 acting as an invisible number pad on a blank screen. Thus although FIG. 5B has a larger number pad with larger regions, a skilled user would find that they could accurately input data using this invisible number pad in a numberpad occupying half the screen, in a more convenient and efficient manner.

FIG. 5D. This shows how using the identical size of number pad of FIG. 5C, the user could then change the behaviour from tapping within a series of regions 2,5,8,0 to input the number 2580 in FIG. 5C, the user could perform the whole sequence of number entry by a single right angled swipe as shown in FIG. 5D. The SP would appreciate that this would be far faster to implement the data entry of four different operations 2,5,8,0, and indeed it would be the fastest and easiest way a user could perform the task of several different operations, with entering each digit being a different operation. It could be made faster by just requiring the user to perform a downward direction swipe within regions 2,5,8 and within 0 removing the digit from the screen, but this would only have the same safety approximately of performing a swipe 7 in the prior art. However, by making the swipe a right angled swipe i.e. performing the horizontal movement from the URC to the MUE the the digit continues moving in continuous contact downward through each of the numbers and as the TDS detects the digit moving within or entering then leaving each region; 2, then 5, then 8 the TDS would input the operation of entering the three different numbers 258 and when the user removed the digit within the region 0 would enter that digit as the last number.

It would be appreciated by the skilled person the right angled touch swipe 516 requires the user to make a right angled change in direction, and this has less probability in being accidentally triggered than swipe 7. Therefore swipe 516 is much safer than swipe 7 and it would be almost impossible turn on the display and unlock the device to the last screen by accidentally performing this operation especially if the screen after the initial detection of the swipe at the URC immediately deactivates if a wrong region e.g. 3 is touched in the wrong sequence, thereby undoing any one or more operations performed by the swipe. The SP would appreciate that a child would have much less chance than 1 in 100000 in accidentally performing this swipe because it require 4 different numbers to be entered in the correct sequence, and also an initial horizontal movement with area 11. This is less probable of being accidentally triggered by a child than the pin numbers used with credit cards. Furthermore, if the wrong sequence of four digits is entered more than twice the device could make the user repeat the swipe 516 2× or 3× making the probability respectively less than 100000000, or 1000000000000. Thus the skilled person would appreciate that requiring the user to enter at least a 4 digit password, with the deactivation of the number pad by a wrong sequence of regions touched (where any region not within the 10 digit region would be also classed as a wrong region) would be safer and quicker than the prior art password entry of FIG. 5A.

Thus FIG. 5B-5D shows how a user could enter a sequence of digits by either a sequence of touches e.g. taps in FIG. 5B or FIG. 5C, or by a single swipe in FIG. 5D in the most efficient manner possible, without a button press, at any time, with the minimum of digit movement over the screen.

Indeed the SP would observe that this ability to enter a sequence of operations e.g. each digit representing a different operation, could allow the user to enter a number corresponding to one operation of the device, and thereby all operations of the device could be entered by a sequence of digits where the number of digits in the sequence was larger than the total number of all the operations of the device. Thus by describing an invisible number pad now provides the user at any time with a method to perform any operation of the device by entering a digit into the number pad, and by this method all operations of the device could be operated more safely than any prior art device or software.

FIG. 5E shows one embodiment how a user could enter any text into the device. This shows how the original nine regions 1-9 shown in FIG. 5B could be used to each have four different swipes. Thus each of these swipes requires the user to place the initial digit contact (e.g. represented by the four tails of each swipe e.g. in region 1 or area 14 in FIG. 5) in a region. Thus as long as the initial digit contact 4 is within the region 1 shown in FIG. 5B or area 14 shown in FIG. 5F, then if the user performs a swipe in a down, left, up, direction with the tail of the swipe being within the region this would respectively perform the Cap, or input a, b, or c letter by each of these swipes. In the same way each of the other regions also could enable the user to perform four different swipe actions as shown in FIG. 5E and thereby the blank display screen becomes an invisible keyboard.

Also at the bottom of the display screen, the lower edge is divided into three additional areas or regions and if tapped within each of these areas could perform three different operation e.g. like Send, View or Cancel.

Thus by this means as shown by sequential photographs a user could enter Hello World into the device.

Thus this method could allow a user to develop a new skill of invisible texting. That is be able to text without any feedback and still know exactly what was written in the text. This may be a common feature indicating user intelligence in 20 years, and this has the advantage of improving the recall and decisiveness of the user by practicing the ability to picture the text message without seeing it written down. The user could at any time see what they had written by the sequence of swipes by touching the view area on the middle lower edge, and when the digit is removed the visible text box reminding the user of what was written disappears.

However, it would be appreciated that an invisible keyboard now gives any SP the ability of a command-line operating system, which a user now can perform any operation using a command line or a list of command lines. Thus all operations of the device and all configurations of the device could be entered or modified using an invisible keyboard. Thus the skilled person would realise by FIG. 5E or a similar invisible keyboard (i.e. the SP could rearrange each of the 4 swipes to perform different operations or enter different keys to have a different invisible keyboard layout designed for a SP who programmed with a command line user interface. And by this method the SP would realise that this new invisible keyboard could have the entire functionality of a command line operating system, meaning by a sequence of touches (in this example it is a sequence of swipes but could be a sequence of touches) the user could operate all operations of the device using the full capacity of a command line operating system which can perform all operations of the GUI in a list format, and since language is not bound by previous prior art languages, in that users or SP can develop new programming functions and procedures to perform by each command line, all operations of the prior art touch interface and prior art GUI can be performed by touch at least by this method, in addition all new modifications to the prior art touch software can be programmed by this method, and all new modified code could be programmed by this method. Thus the ability of touch to input reliably and repeatedly a language by an invisible keyboard by this example embodiment would be understood to make this new touch interface which is not dependent on any visual appearance of the screen, or even a display screen been turned on or any of the other dependencies of the prior art described in FIG. 13, would make it obvious to the skilled person that this new touch interface had unlimited capacity to perform all the previous touch operations but invent all the invisible touch operations and modifications to the existing prior art GDE with improved efficiency of operation of the modified GDE of the prior art all through this new interface.

Thus this new touch interface is revealed as having at least the following characteristics above the prior art. The touch interface is a true touch interface in that it can perform an operation at any time when the memory of the device is powered e.g. to remember at least the last screen accessed. It is a touch interface because it requires only touch on the TDS to perform one or more operations of the device, and does not require any external button or any of the dependencies listed in FIG. 13.

It is at least the simplest, easiest, fastest, most efficient, least power consuming method, of performing an operation or a sequence of operations (i.e. a task) of inputting data reliably and safely on a computer even when used by children. Its capacity is to be completely backward compatible to all prior art input methods, however, it is different from the prior art in that in its essential form, it can fully operate the device by the processor detecting touch of one or more digits on the TC of the TDS at all times while the device is powered without any other input needed on the surface of the device, where no prior art touch device or touch software could claim that scope.

Indeed the invention was seeing that by the simplicity of touch (devoid of any need to be subservient to a button press and a display screen being on or even the teaching of a GUI which required as essential graphical display elements (GDEs) to exist in order to determine what operations the touch would perform) having the capacity to perform everything the prior art could perform, but by a better more user friendly gliding touch interface, with an unlimited capacity to perform all the operations of the command line interface by invisible touch operations and also to be able to perform operations both with the display screen on or off (impossible for the prior art). In short, seeing that this new interface could modify every existing prior art software or device to perform at least one operation more efficiently with less steps and/or less digit movement on the surface of the device than any other prior art input method. Indeed, a SP would recognise that all programming now will be improved by the touch operation of invisible, instant, independent touch being able to improve the performance of any prior art input method. Indeed as discussed in detail in priority documents in every aspect it is superior to the prior art touch devices or software.

### FIG. 5F.

This shows the display screen 12 divided into 9 regions

In short, these regions are regions in the user's imagination representing an area of a blank turned off display screen and the areas 14, 50,51, 502,501,500,505,504, and 503 are the invisible screen areas shown on FIG. 5F corresponding to the regions 1,2,3,4,5,6, 7,8,9 in FIG. 5B.

The purpose of FIG. 5F is to show the range of touches that are performable by a user. As discussed it would be obvious to the SP that the user can identify accurately a single location at all the corners of the display screen, that is the left upper corner LUC or upper left corner ULC, right upper corner RUC or upper right corner URC, left bottom corner LBC or bottom left corner BLC, and right bottom corner RBC or bottom right corner BRC. Thus one location touched or tapped can occur in these locations. Furthermore, in the imagination of the user the user can identify at least four further locations. The middle upper edge MUE or UME, the middle right edge MRE, the middle bottom edge MBE, and the middle left edge MLE. Thus at least 8 areas on the displays screen a user can reliably and repeatedly touch without error on a turned off display screen.

In reality the division into regions and locations can be much greater than this with practice (e.g. FIG. 5C rather than FIG. 5B) because the user becomes very adept in dividing the screen into different regions of locations in the imagination of the user, and therefore all operations shown in FIG. 9 could be easily and reliably repeatedly performed to detect touches (i.e. contact) or taps at the circles areas of a small screen like a watch screen and directional slides or swipes between these circles as shown in FIG. 9.

However, with just 4 swipes as the only touch shown in each of the nine regions shown in FIG. 5E, this has the capacity for 36 different operations. However it would be appreciated that the user could also perform an operation by a contact represented by the square 510, a tap represented by the triangle 511 (or the arrow head tip shown in FIG. 5B e.g. within region 2), a slide of continuous locations touched represented by a line 512 which as described in claim 2 can be a slide in a certain direction, or a slide in two or more directions 513 symbolised by two lines and an angle, or a swipe 514 symbolised by an arrow with the tail being the initial contact of the path of the digit moving on the screen from the tail within the path of the body of the arrow in the direction of the arrow along a plurality of locations on the screen until the digit is removed at the tip of the arrow as shown by all the swipes (e.g. swipe 2 and swipe 3) on the rest of the diagrams.

Thus the touch of claim 1 includes each digit performing any of the touches described for FIG. 5F, and these can be performed simultaneously or in series by one or more digits. Furthermore, FIG. 5B and FIG. 5C shown that a series of taps can cause an input of a number and that number can perform the operation of claim 1. Thus the touch of claim 1 can be a series of touches e.g. a tap. FIG. 5C shows how a single swipe can perform a task of input of a number and thus the touch could be a single swipe as the touch performing any operation of the device. However, it would be understood by FIG. 5F that any simultaneous touch of two or more digits e.g. two digit making contact at two locations e.g. right index finger at MUE, and right middle finger at URC simultaneously to perform the operation or two different swipes simultaneously or two slides simultaneously. Indeed any of the touch of two or more digits in sequence (i.e. the location touched of right index finger touching the MUE before the right middle finger touching URC could be the touch of claim 1.) to perform an operation could also be the predetermined movement of the touch of claim 1.

FIG. 5 G shows a swipe 700 which starts at the LBC and moves along the bottom edge and is removed at the RBC to perform turning on the display screen and showing the last screen, illustrates that swipe 700 is a longer swipe than swipe 7 shown on a turned on display screen of the prior art. Thus the skilled person would realise that swipe 700 would be less likely to be accidentally triggered than swipe 7. Furthermore, the sequential photographs show that this movement is an available movement on the existing iPhone to perform the operation of unlock. Thus this photograph shows how easy it would have been for a SP to have enabled this invention on the identical prior art software. Indeed the SP only needs to turn on the TC of the TDS as shown in FIG. 1c from the prior art configuration where the TC was turned off in FIG. 1b. This then makes the prior art software screen permanently sensitive to touch even when the display screen is turned off. Thus, it would be appreciated if FIG. 5G had the DC turned off but the TC turned on then this would show an invisible screen and then if the user just performed swipe 700 using the existing program except modified to turn on the DC after the completion of the swipe 700, this would be an equivalent swipe to swipe 2 on FIG. 1A. The only difference is the swipe 2 position is more efficient and ergonomic for a right thumb. However, the skilled person would realise by just a few lines of code, it would have been that simple to convert the prior art touch device method of FIG. 5G, to the invisible touch during sleep mode of the independent touch of the invention. The purpose of FIG. 5G was to show how easy the enablement was of the invention, and also that it makes obvious the inefficiency of the prior art input method. The input method would require the user to press button 1 (or home) and then move to perform the swipe 7. The new touch require the user only to perform swipe 700 which is faster, easier, safer because it specifically is longer and a more precise touch then the swipe 7, that deactivates or is undone if it is not precisely done, and does not require any pressing and uses less power performing the operation because the display screen is turned off when the user performs swipe 700. Thus this makes it obvious to any skilled person that the design of this turning on of the display screen and unlocking is superior in every aspect to the prior art.

### 6A

This shows how by a single swipe the operation of a task can be performed. A task is the performance of a sequence of operation. Thus the user starts a slide motion 11a in FIG. 6A from the URC to the MUE. Then the downward slide 60 can activate turning on the display screen to show a graphical appearance to assist the touch completing the task. [This is different from the prior art which turns on a GDE in order for the user to activate the GDE by the touch]. Thus the touch in independent touch can operate independent to visual feedback, but if visual feedback is used it may be responsive only to the input of the touch. In addition the initial downwards slide can turn on WIFI or radio signals (thus limiting the power loss of these high draining power operations only to them being needed). In order that the user can search a connected database to download a record from the database from a connectively coupled computer (e.g. internet or local LAN) which requires the user to input data to solve a task. The downloaded data is sent in a list format which can be displayed as menu items on the touch device. The searching of the record and the download of the data is not shown but it could have involved numerous different embodiments to search the connectively coupled computer from the simplicity of a single field where the user could type the first letters of important words (e.g. like the first letters of a surname followed by a space followed by first letters of a first name followed by a space and then a date of birth followed by a space by a condition e.g. chest pain). Then the record that would be perfect for the user to solve or perform a task e.g. asking all the relevant questions regarding chest pain for that patient) would then provide a list of data as a downloaded record from the connectively coupled computer in order to perform that task of several operations. And in order to perform that task perfectly the user needs to input a correct response to the following download data items in sequence.

### FIGS. 6AA and 6AB

Show two sequential shots of the same screen to illustrated the record of downloaded data was data elements 1 to N, where N could be any number not just the 8th data element on the second page (i.e. it could be the 12 data element on the third page etc). The important aspect of the Nth data element is that for the user to perform the task completely the sequence of selecting a response option for each of elements 1 to N is necessary in order that the task is completed. And the purpose of FIGS. 6A, 6AA and 6AB is to show that this task can be completed by a single swipe using the embodiment shown in FIGS. 6AA and 6AB.

What FIGS. 6AA and 6AB is showing is that the user can first start with slide 11a, then make an initial downward movement in downwards slide 60 which may allow the user to search and download data from a connectively coupled computer in order to perform a task which could have n elements to complete. This list of n elements is then received by the touch device as shown initially on FIG. 6AA where the user then selects Yes for the data element 1 610, No for the data element 2 620, and uncertain for the data element 3 630, and no for the data element 4 640, and then moves over an area at the bottom of the menu which makes the four elements 640, 630,620, 610 fill up respectively with the next data elements 5th, 6th, 7th and Nth, which the user then continues the long swipe by sliding back up the screen and respectively performing the operation of recording no, uncertain, no and Yes for these respective elements. Since the Nth element 610 is the last element of the task operation that needs a selection of Yes, No or uncertain to be performed to complete the task. This data could be uploaded the moment the user lifted off the Nth element 61 in FIG. 6AB. Usually there may be a separate element in the list above this which the user could move over to save the data and upload the data to the connectively coupled computer (e.g. similar to menu item 64 in FIG. 6B. The important aspect of this is that this shows one way elements or operations that needed to be performed to complete a task of 1 to N elements can be performed in a single swipe and indeed, N could be a very large number where the user is moving down and up as shown in FIGS. 6AA and 6AB numerous times so that a very large task on numerous operations can be performed by a single swipe. Thus this FIGS. 6AA and 6AB clarifies that the operation of claim 1 may be a task of a sequence of operation performed by one or more digits.

Thus after considering all the possibility of any touch being the touch of claim 1 or any operation being the operation of claim 1, it becomes obvious that this method can include a touch which is a single swipe performing numerous operations of a task and being able to complete that task without missing one important operation in a single swipe.

Now the skilled person would be able to appreciate that businesses could dramatically improve their efficiency by writing lists of tasks needed to be performed by an individual, and then allowing that individual to download that list of operations which needed to be completed to perform the task, and when that individual had performed the task could record the results of completing the task in the time saving and easy manner of a single swipe. The SP would realise there is no simpler or quicker way of using touch to ensure completing a task than this, and because it is sequential nothing is ever missed.

Thus the importance of this is in reliable data recording because this method forces the user to specify exactly what information was gathered or done in performing the task.

### FIG. 6B

This shows a simpler task that could be completed on a single page of the menu. It shows how a user could perform an initial touch e.g 11a and make a downward movement 60 (which may download data as described above) and then the user can in a single swipe enter Yes, No, Uncertain for the elements 61, 62 and 64 respectively and then saved this recorded information of the completed task of three operations by sliding within each label area by entering and exiting only one choice per menu item and 65 shows that the display screen could be turned off immediately after the information was save (and/or uploaded to a connectively coupled computer) to save maximum power by turning the DC of the TDS off by removal of the digit at 65.

### FIG. 6 C

As described in FIG. 6 A a user can search using a string of data in a field for a patient record and a condition from a coupled computer in order for the user to receive from coupled computer downloaded data in the format of a list of data regarding the patient which can be imported in the form of data in a list of menu items. The data can comprise of background information regarding the patient including demographical data, and then the patients history, examination, investigations and management stored on the NHS spine. However, in addition the user can receive further data that needs to be inputted in order to complete a task of data input for a given one or more presenting conditions e.g. chest pain which the user would have already supplied in the search of the coupled computer. Thus the connectively coupled computer can provide both the patient data and the data required to complete the task of complete data entry for a presenting complaint.

FIG. 6C shows a computer which has received both the patient data and the task of data elements required to be completed in order to complete the task of data entry for a presenting complaint.

It is well known in the prior art of medical computing of all the possible ways a computer may output medical data currently e.g. in EMIS web provides a means in a list format for every possible type of medical report, and depending on the user the patient data on the NHS spine could be listed with all relevant patient data for the purpose of data recording the specific patient complaint.

Thus this can be downloaded to a touch device as shown in FIG. 6C. Because this medical example is an ambulance situation, the 111 operator has already taken the patient details, and the presenting complaint of the patient needing an ambulance, and the address that the ambulance is going to. Thus when the ambulance arrives at the location, and the paramedic or doctor starts the initial swipe 11 and makes the initial downward movement, at this point the device can receive WIFI or telephone signals (e.g. 3G or 4G) to upload the GPS coordinate of the ambulance and the relevant next patient's details that the operator has already entered. Thus the information of the patient stored on the NHS database could be supplied in a known and agreed list format for the ambulance service so the doctor could scroll through the data elements in the conventional manner in region 65. Region 65 is a special modification of the conventional scroll operation (e.g. list of contacts or message etc in the prior art touch software). The region 65 which is a region of the right side of the menu items is an area which cannot enter data unlike the conventional operation. This is a design feature to make the region 65 for navigation purposes only, and not performing operations. This has the very useful function of providing the scroll area 65 (which could be varied to the size the user finds best) which means that on this side, patient data cannot be altered thus the user can quickly scroll up and down on this side of the screen or rest his digit on this side of the screen with no fear that it will ever enter data or alter data for the patient. Thus FIG. 65 is showing the user having turned on the device in the ambulance, is provided with the next patient's data (saving all the unnecessary paper recording of information the NHS has already got), and the paramedic can read the patient's medical data stored on the NHS spine according to an agreed ambulance format. Since the demonstration is on a tiny phone this would require the user to scroll through the patient's past data until the user reached the 1st Data Element with a Yes No or Uncertain option.

In reality this would be titled something completely different e.g. Information needed to be captured for the correct assessment of the presenting complaint of chest pain. Thus when the Dr see this, the doctor or paramedic knows the listed data in this section requires at least the paramedic or doctor to complete the input to all the data elements to perform a complete task of input regarding chest pain. Thus the 1st Data Element to the Nth data input would be all the questions, examination and investigation results needed to be entered to be uploaded to the NHS spine or other connectively coupled computer in order to properly diagnose and treat the chest pain according to the latest best guidelines.

### FIG. 6D

Thus FIG. 6D shows the beginning of the list of data elements that needs to be inputted for the correctly completed task. Indeed some items may require the user to access one or more additional screens using a touch e.g. a left reverse slide touch 72 (this is where the user touches the area to the left of the scroll area 65 and slides a digit in a left direction and then reverses the direction to a right direction to show another diagram FIG. 5E.

### FIG. 5E.

FIG. 5E shows examples of the essential vital readings that the paramedic do, like systolic BP 73, diastolic BP 74, pulse 75, temperature 79 etc 76,77,78 in diagrammatic format (so it is very easy by a touch to enter the readings) in FIG. 6E and when that section is completed performs another left reverse slide touch to go back to the list of data elements that need to be completed. (This is only one possible embodiment how a user may added data to the menu items, a SP could devise others.)

### FIG. 6F

FIG. 6F then shows by a user making a single swipe 71 to select the various data options as confirmed, not present, or uncertain, on the first screen, and on the lifting off of the digit on the Automatic page down menu item, this may automatically show a second or remainder screens for the user to swipe to capture all the necessary data input for every element that would comprise the state of the art data capture for that presenting complaint, with the user being shown to finally have swiped the last menu item page 81 on FIG. 6 G. On receiving that all data input is entered for the first data element to the Nth data element to provide the NHS spine or connectively coupled computer with this state of the art data capture, the NHS spine may then send further management steps for the Dr and the paramedic to make for perfect treatment of that presenting complaint.

When the paramedic has then followed those steps, he can then perform a swipe 82 which then enters all the suggested management steps as completed. Indeed one of the management steps could be any other user selected management steps which allows the user to add any steps in addition to the suggested one. On completion of this swipe the computer can upload the data.

Now this system shows how fast this swipe system could be, with automated steps making the minimum of swipes to perform the operation, and using automation as much as possible i.e. when the user selects all the data elements which require input for the task, this is automatically sent to the spine, to minimise the time of the paramedic on the touch device e.g. iPad in reality instead of the iPhone touch device (unless the paramedic is on a motorcycle). Indeed although not shown in the same way that all the data elements could have been entered by a single swipe in FIG. 6AA-6AB this may be an alternative method of selecting one option for a task of several data elements.

It would be appreciated this schematic method of entering data has numerous benefits for the complicated task of data input for every presenting complaint for every patient in the NHS.

The data received from the connectively coupled computer is from two sources

1. Patient data as recorded on the NHS spine.
2. A set of input tasks for every presenting complaint for perfect data capture of that complaint.
3. A set of management tasks for data input responses for every presenting complaint.

In addition the computer has an algorithm which allows further questions to be asked based on the patient's data with reference to the presenting complaint to provide further data input to be captured if necessary.

Likewise when the data input is completed and received, then another algorithm will produce the essential management steps to be performed for that patient with that presenting complaint and the captured data.

Thus the set of input tasks for every presenting complaint could be continually updated centrally which would mean that the user always got the latest most perfect known data input needed and management steps for every presenting complaint, likewise all the captured data would be stored centrally so that no information was ever missed being captured for a patient.

Thus by having the two components of patient data and a list of input tasks for every known presenting complaint and management steps for every known presenting complaint according to the data input for the presenting complaint managed on a single NHS spine this will allow for exponential accurate data input for patients and provide a minimum standard of the highest medical management for every presenting complaint according to the data input response. This will avoid all duplication of patient data, and enable a level of uniform care throughout the NHS.

Thus this will lead to a central research tool which could make new discoveries by its accurate data input to a single central source. Furthermore, it could allow any touch device with WIFI to be used by Drs. Indeed, a perfect data input system, is a goal that health computer specialists have been seeking for years, and now with the inherent superior properties of independent touch, has been simplified to the above example. Because in the same way health staff like paramedics could access this central data and central database for input tasks and management steps for the input tasks, so could hospital doctors doing a ward round. The staff could carry an iPad and which would be low powered without WIFI until the doctor needed it so it could be operated nearly all day. The user when they entered a ward could invisible touch and the GPS would identify the ward and identify all the relevant patients in the relevant beds on the ward and may display in a ward layout with the relevant patients highlighted. The Dr would then take a picture of the armband to confirm the patient (indeed a similar arrangement could be done in primary care). This would be a double safety confirming the patient details, as the Dr can also confirm verbally the patients identity. Thus the combination of using GPS and independent touch connectively coupled to an NHS spine, would make the most efficient method for recording a medical task and providing a multiuser input to an NHS spine where every entry for every patient is never lost, and can be used to improve the patient care to have a unified high standard of care across the country, while saving millions of pounds of staff time because it eliminates any unnecessary duplication of medical recording for each patient. The uploaded data will be time stamped. Thus the hospital may have its own computer storing bed locations and other information for administrative purposes for the patient, however this computer can also have an exact mirror copy of the patient data on the NHS spine. Thus removing any lag in retrieving data regarding a patient admitted to the hospital, and when the doctor then modifies the patient data record of the NHS spine, as the input time by the Dr will be date stamp, this can be added to the NHS spine in a mirroring process at a different time so the Dr does not experience any lag or slowness of the downloading of data or input method. This mirroring can apply to primary care or any other medical user of the NHS data so that although all this data is stored centrally, this and other methods may prevent any lag at accessing any NHS spine data.

FIG. 7 shows a right forefinger with an attached stylus. The stylus can be a miniature stylus which can be detected hovering over the screen attached to a metal clasp which nearly goes round the digit distal to the DIP joint. It may or may not be pressure sensitive. The stylus does not need to be touching the touch-sensitive screen to be detected. The stylus only needs to be less in size than from the DIP to the tip of the digit, and it may be pressure sensitive but it does not need pressure sensitivity as essential as the purpose of the stylus is to identify one digit as the dominant digit. Its main purpose is to effortlessly enhance writing on a touch surface, without the problem of losing the stylus, as the metal clasp attached to the stylus may be made of malleable but firm metal designed to cover about 75% of the circumference of the digit tip so that so that the finger clasp attachment can be firmly attached to the digit tip, with the stylus ideally placed for writing. When the thumb is detected by the TDS touching the stylus, then the stylus automatically allows the user to write with the stylus like a pen with a soft plastic tip. The clasp allows the mini stylus to be positioned when the user is typing to be further up the digit not to interfere with typing but yet still allowing the attached stylus to be detected as a dominant digit. As the dominant digit, this can be used as a pointing digit of a pointing device in a traditional GUI pointer based operating system like Microsoft Windows. Thus this pointing digit only moves a pointer over the screen. If the user detects other digits like the thumb or middle finger touching the screen (i.e. left or right digits to the forefinger then these digits could be secondary digits to perform all the standard left and right clicks for a graphical element that the pointing digit is over e.g. an icon on a windows desktop. Thus if the pointing digit is over a Microsoft icon in Windows 7, a single touch of the thumb would the equivalent of the left mouse down of the thumb, the removal of the thumb digit would be a left mouse up, a tap of the thumb would be a left click, a double tap of the thumb a left double click and a treble tap of the left thumb as a treble click. Thus all the left mouse button click functions could be performed by a right thumb. In the same way, all the right mouse down, up, click, double click and treble click could be similarly performed by the right middle digit. The wheel up could be done by the right thumb, forefinger and middle finger simultaneously moving up the screen, and the wheel down of the mouse could be done by the right thumb, forefinger and middle finger simultaneously moving downwards. Thus in this way a pointing device could be easy replaced by using three digits of the finger with the forefinger being identified at all times, so if the user rests his right hand on the screen with five fingers resting on the screen, then only the pointer moves over the screen. By a simple modification of the touch-sensitive screens of the laptop tablets (, or a desktop TDS like the Cintiq PL 550 except the plastic could be a flat TC like the iPad), making the windows desktop display screen smaller than the total touch-sensitive component of the touch-sensitive screen can mean even if the pointer is positioned over the edge of a display component of the display screen, at least the right thumb, forefinger and middle finger will be detectable at all times no matter on which edge of the display screen the digit is touching. This would complete the seamless link between the old pointing based graphical interface (which now the true touch interface can seamlessly imitate) which now a user just need a desktop or laptop or tablet or iPad screen with a small display area to be able to detect the 5 fingers of a hand, and suddenly we never need pointing devices. Indeed it could be appreciated that for just the forefinger as a pointing device if the user rests his five digits on the cintiq like TDS, the predetermined movement of the digits of the hand (e.g. right) can be a replacement for the pointing device (mouse). When the five fingers are all resting on the screen this moves a pointer with a coordinate location of the index digit. If this points to a touch GDE 135 of the prior art, if the user lifts up the thumb and touches the screen this can replace the left mouse button, and if the user lifts up the middle finger and places it down then this could be the right button. If the user lifts the hand off the screen this deactivate any click process. Thus this shows just using a hand with no stylus how the predetermined movement of claim 1 can be fully compatible as a pointing device for a prior art GUI. However, a stylus would be better for smaller screens. Again the purpose of this description was to show how this new touch interface i.e. the touch of a predetermined movement of one or more digits (independent to button presses, independent to the display screen being on, and independent to a graphical element, can be made 100% backward compatible to a pointing device because this is always the characteristic of a simpler interface in that it can always be arranged to emulate a prior art method (in a more ergonomic method).

The real advantage of the attachable stylus to the digit is that while it is attached to the digit it does not get lost. And with it a child could write all their notes on an iPad with writing as good as real writing and all that writing could then be converted into searchable text, or searchable text in a pdf format which will locate the graphical written word. Thus this is one advantage of an attached stylus. It is hoped if this gets popular may shops will sell several of these mini digit attachable styli.

### FIG. 8

This shows the touch component TC of the TDS, as shown in FIG. 1C. It will be noticed that the TC has a larger surface area than the DC screen area of the TC which is represented by the clear transparent rectangular area of the screen which allows the DC of the TDS shown in FIG. 1C to be seen as screen 12.

As the invention now is able to allow touch to be detected at any time on the touch-sensitive screen, one or more methods may be used by the skilled person to decrease the power consumption of the TC of the TDS being on all the time. One method is to reduce the power consumption by manufacturing new TC which can power smaller areas of the TC, e.g. the screen area 802 which is approximately the size of the path area 10. Thus if only this area is continually powered then when the user makes an initial left direction slide from the RUC, this then powers the remaining part of the TC. Thus the power drainage of this new TC would be considerably less than powering the whole screen.

Another alternative method is to have an array of solar cells 801 which could be charging a capacitor to continually power the minimal power of the 802 area to detect touch. In this way if the array of solar cells was sufficiently large e.g. over the black area of the TC, this method could be charging the battery or capacitor during the daytime to at least power the circuit for the 802 screen area to be always on. In this way even though the TC is continually powered, if only a small area is powered of the TC initially and then a specified movement caused the remainder of the TC to be powered, thus minimising power loss until the TDS would require full power to detect all movement on the screen if the user always touched the screen with an initial touch e.g. 11 or 11a.

Also by using solar power cells this could cause the TC to be powered and if there were enough solar power cells the TC could be continually powered as always on by the solar power cells. Thus by these two or other method, it is easy to see how new phones using invisible touch could make the TC more efficient than a button press turning off the TC completely in the prior art sleep mode. However, it would be appreciated that the prior art touch software always would use more power in performing the operation 136 because it always required the button press 1 to turn on the display screen and the touch component in order to perform the operation, and that would always be more power than performing the identical operation 142 without requiring the DC of the TDS to be on 141.

However, for the reset button this could be performed by using a solar power cell array 801 as a separate backup switch on the TC of the TDS. It would be appreciated that an array of solar power cells 801 could be providing power, but also if the user touches over the solar power cell a decrease in power can be detected compared to the other cells, and by this means a touch could be detected over the solar power cells and if it is as specified e.g. a sequence of taps in one or more locations or a swipe over the array then this can be used as a backup electronic switch on the TC of the TDS to independently be able to perform an operation (e.g. send a GPS coordinate if the TC or DC of the TDS was damaged) The array of solar power cells also could be positioned attractively outside the display area.

Thus a reset button, and even a complete power off, could be done by touching a specific area e.g. 801 e.g. holding the screen for more than 5 seconds then tapping three times then holding the screen for more than 5 seconds or whatever pattern the user would want to activate the reset button. With the power off button this would normally always have at least 801 on the TC of the TDS turned on 141 by a separate circuit so it would not be affected if the TDS froze.

Alternatively because the TC of the TDS now can continuously detect touch, there is no need for an external button on any touch device, and with induction charging, and blue tooth headphones, and wireless connectivity to being connectively coupled to another computer, and all operations performed by all external button being performed by the TC of the TDS, then there is no need for an external button because the TC of the TDS can be accessed faster to perform an operation. Thus the new phones could have internal buttons or switches where the battery is stored to additionally reset the device or completely power off the device (i.e. no power at all) if the battery needed complete conservation e.g. for a trip into the jungle, and the phone was going to be used just for contact in case of emergency. In this description the TC can be larger or extend greater than the DC which is already known, however, the TC may become more complicated areas in devices in the future to have separate circuits incase the main screen froze, and these areas may be on different surfaces of the device in addition to that shown in FIG. 8.

FIG. 9. FIG. 9 shows another set of touches and taps at the circles of a touch-sensitive screen shown in FIG. 9 and also swipes or slides between these circles all as other ways of executing operations on a blank screen, even the miniaturised blank screen of a iWatch or equivalent. Furthermore the ability of touch to be performed on crystal glass (like the iWatch) FIG. 10. This shows an analog watch (e.g. like a Swiss watch). It has a crystal or glass watch face 814 and a TC 810 and a DC 811. The TC can be constantly on and/or with an area of the screen only powered and powered if necessary by an array of solar cells on the face of the watch, and/or by battery power. Thus the screen by touches can perform an operation including sending an instruction to another mobile device e.g. to download emails or text. The important aspect of this design is operations may be performed with the DC of the transparent LCD screen which allows the user to see the beauty of the mechanical face of the watch, but also having the control of one or more operations on the face of an analog watch operated by touch. The IT could be applied to any jewelry or other portable items.

### FIG. 11

This shows how silent mode could be more conveniently performed by a user. The user could at any time put the device into silent mode or alarm mode by a variable swipe 110 as one embodiment. Thus the user starts on the URC and moves downward on the right edge, as the user moves downward the user passes location 111 this is silent mode, and the display screen provides feedback when the user is over silent mode by showing the text silent mode over the screen in a low power mode, the user could remove the digit while this mode was shown and this would put the phone into silent mode and the display screen would immediately turn off on the lifting of the digit. The user could put the phone into vibrate mode by ignoring the text for silent mode and continuing the swipe 110 until the text “vibrate mode” is shown on the display screen at location 112, again the user could select this mode by lifting up while this “vibrate mode” was shown at location 112. And lastly if ring mode is needed the use ignores the vibrate mode display and continues to move the digit in contact with the display screen at location 113 and the display states ring mode and then removes the digit at this location 113 this would set the phone in ring mode. However, if the user forgets to turn on the silent mode in a meeting and the phone goes off, the device can be made silent by the user touching the TDS. This will immediately stop the ringing, and then the user can pull out the phone which would be blank as shown in FIG. 11a and perform a slide to the location of the arrow head 11 and this would turn on the display screen to show the notification e.g. the alarm screen. which the user could slide over the screen and lift off to keep the screen on and answer the notification or lift off at MUE to give a not available message to any text or phone and to turn off the notification and do nothing else. Thus this method would be appreciated as much faster and easier than any silent mode with buttons.

### FIG. 12.

This shows one embodiment a user could design their own independent touch interface containing the steps of the embodiment to record a touch and select one or more operations for a touch on one or more locations on the swipe as shown in FIG. 3 or 4.

One of the advantages of a WYTIWYG interface is that it is simple for a user to record a touch and select one or more operations to perform for that touch, or to modify a touch to perform one or more further operations at one or more further locations touched along the path of a digit moving along the screen e.g. the swipe 2 as shown in FIG. 4 being modified by an edit program.

Thus the user could perform an initial touch 11 swipe. This then activates the swipe 15 to get the camera application, the swipe 16 which accesses the video application, the swipe 17 that allows for the prior art voice recorder application, the variable swipe 18 which allows a user to scroll through for the latest notifications for SMS, the variable swipe 19 for scrolling through the latest notifications for missed calls, the swipe 20 for invisible dialing on a blank screen (the user just dials the number using FIG. 5 B or FIG. 5C using an invisible keypad and then touches or taps a send button (not shown but may be positioned to the left of the region for the 0 in the same relative position to the send in FIG. 5E), the swipe 21 for the invisible texting on a blank screen (e.g. the use swipes as described in FIG. 5E and then touches the send button), and the variable scroll swipe 22 for the music player which can scroll through albums showing the first songs of the album or playlist showing the first songs of the play list as shown in FIG. 4A and when the user has scrolled up or down to find the right album can lift the digit off to start playing that playlist.

The user can turn off any display screen or any selected application by performing the swipe 3, and if the user has performed an initial swipe 11 and changes their mind about accessing one of 15 to 22 swipes, the swipe 3 will deactivate that initial touch 11. Furthermore all these prior art applications displayed with the conventional GUI appearance in the prior art all do not require the user to fully unlock the device. All these can be accessed quickly without unlocking the remainder of the functions of the phone, so the use could answer or perform any of these operations without the phone being unlocked so that the user is restricted to just those applications on the device. This method could also be good for a user with children by allowing selected applications to be accessible by the child without fully unlocking the device. However, if the user wishes to unlock the device the user would just perform the swipe 2, which would turn the display on and unlock to the last screen in the normal manner.

### FIG. 13

This shows a flow diagram of the prior art which show without steps 131 to 135 it was impossible for the prior art device perform an operation by touch or a touch operation 136 by every device with a TDS (touch device) especially all the modern prior art touch devices operating by iOS, Android, Windows Phone and any other equivalent software. The prior art touch device could be any device with a TDS e.g. iTouch, iPod Touch, Nintendo, Sat Nav, iPhone, iPad, iWatch, or Windows Surface or any equivalent to any of these devices all which had a TDS and an external button and displayed a graphical image on the screen (graphical user interface GUI) which had one or more graphical elements displayed (graphical display element e.g. desktop, window, icon, menu, or any other graphical control) on the turned on TDS, and by touching one of the GDEs e.g. the slider 7a in FIG. 2AB). Indeed all the iOS devices (iTouch, iPad, iWatch and iPhone) or any equivalent device are the preferred device in the prior art to illustrate the difference of the invention, all the drawings have used an iOS device as a representative prior art touch device which has at least the essential component of a TDS and an external button 1 or switch on the side of the device, and perform at least to the steps of FIG. 131 to FIG. 136 of the flow diagram to perform a touch operation. However, it would be understood that any iOS device could be substituted by any other Android or Windows Phone or any other equivalent device with a TDS and an external button and operated according to the flow diagram of FIG. 13. However the SP should assume that when the representative iPhone is described it could refer to any device manufactured by any company with at least a TDS and an external button 1 or switch or any mechanical equivalent) on the surface of the device.

Thus if we use FIG. 2AB we can see all the steps of FIGS. 131 to 136 in order to perform the touch operation to unlock the device. FIG. 2AB shows that device has a turned off TDS. This in the prior art meant as quoted by the latest iOS manual that the screen “can do nothing” and it “saves battery power”. Thus all the devices within the field of this invention have a state where the device has a turned off touch-sensitive display screen TDS, where, both, the touch component TC (01 shown in FIG. 1B) is turned off so it is impossible for the TDS to detect touch when it is not powered, let alone perform an operation, and the display component DC (02 shown in FIG. 1B) is turned off to save battery power. This has been the state of the Art for all devices since 1992 which was illustrated in the priority documents diagrams showing the IBM Simon in 1992 and the Beta Apple Notepad in 1993 had this configuration. Indeed the state of a TDS turned off 131 was essential every since the IBM Simon as it increased the phone processor and memory being powered by turning off the TDS from 1 hour to 8 hours to improve the power management of the device. And when the iPhone was manufactured, one of its major problems was battery life so it used this conventional mode of sleep mode whereby a user could press on and off an external button 1 on the surface of the device to conserve power.

Thus while the device is powered, there always is a period of time in the prior art device where the TDS is turned off 131 and not powered. Thus since it is impossible for any touch to be detected with the TDS turned off, the user has to use another input method, a button 1 press 132 or equivalent to turn on the TDS as shown on the iphone in FIG. 2AA. In FIG. 2AB this shows the display screen turned on 133 by the button 1 press 132, and the display screen shows a GUI 134 appearance of an unlock screen, with a GDE 135 slider 7a within the GDE 135 slider control 7b boundary. Thus this GUI 134 (graphical user interface) means that in order to perform an operation the user must see a displayed image e.g. the unlock screen and then perform an input e.g. a button 1 press to turn off the displayed image or a touch operation 136 swipe 7 to perform the unlock. However, the GUI 134 requires as essential the step that a GUI image needs to be displayed on the screen to make the user know what input is needed thus without the image of the unlock screen in FIG. 2AB the user would know that it was impossible with the iPhone to perform the unlock touch operation 136. Thus FIG. 2AB shows that the display screen showing a GUI 134 is an essential step in order to perform the operation. Without the button press 132 the display screen been turned on (step 133) or the GUI unlock image (step 134) being displayed on the TDS, it would not be possible to perform the touch operation 136. This was because the GUI 134 was a “What you see is what you get” WYSIWYG interface that is the screen reminds the user by its appearance of what input operations are possible by that screen. So if the user sees the unlock screen in FIG. 2AB, the user knows that GUI 134 image is programmed to detect the input of touch operation 136 of swipe 7 and being responsive to a button press 1 to turn that image off. However if the user sees a GUI 134 blank screen or GUI 134 of a turned off screen, the user knows with a GUI 134 blank screen that no touch can perform any touch operation 136 as the blank screen appearance of the GUI 134 was designed in the prior art to perform no operations by touch. Thus the GUI 134 appearing on the screen and showing an unlock screen of the GUI 134 is an essential step to perform a touch operation 136 on that device, as the GUI 134 showing a GUI but a turned off blank GUI screen 134 appearance was designated by this appearance to never perform a touch operation. Furthermore, in addition to not showing a GUI 134 blank screen of the sleep mode but an unlock screen of the GUI 134 to enable the user to perform touch, the user requires an additional GDEs, the GDE 135 slider 7a and the GDE 135 slider control within its boundary 7c in order to perform the touch operation 136 of the unlock. If the GDE 135 slider 7a was not present then the touch operation 136 of the unlock could not be performed.

Thus the requirement of the GDE 135 slider 7a being present to perform the touch operation means that it is impossible for the prior art to claim that it was only one or more locations touched apart from the visual feedback from the GDE 135 slider 7a to perform touch. This becomes obvious if we consider how the slider 7a is required as essential in addition to perform the swipe 7 (as the identical locations touched of the swipe 7) on a GUI 134 blank screen in sleep mode would not perform the unlock operation; i.e. without the essential two steps of a GUI 134 screen image of the unlock screen, and the GDE of the slider 7a) being displayed on the turned on TDS, with the TC being turned on 133 to detect the touch, it would have been impossible for the prior art touch device or prior art touch software to perform the unlock touch operation 136.

Thus a SP carefully considering just the swipe to unlock operation of the iPhone as a representative touch device would understand it was impossible for the prior art WYSIWYG GUI 134 touch device ever to perform a touch operation 136 independently as the touch operation without being dependent on steps 131, 132, 133, 134, 135 would be inoperable and impossible to perform by the prior art touch device or the prior art touch software (e.g. iOS, Android and Window Phone). And this would be obvious to an averagely skilled person SP because any user would realise it was impossible today on the 28 Nov. 2015 because all the steps 131-136 are still essential for all the devices with a TDS turned off during a period when it is powered 131 and an external button 132 on all the latest devices operated by just released iOS 9, or Android Milkshake or Windows Phone or Windows 10 devices or any other equivalent software.

### FIG. 14

The comparison of FIG. 13 to FIG. 14 shows why the WYTIWYG is superior to the WYSIWYG. The first obvious reason, that a SP would recognise is that the FIG. 13 is at least 6 steps to perform a touch operation, and FIG. 14 is one step making the WYSIWYG incredibly inefficient compared to the WYTIWYG. The second reason is that at all times the user can perform a touch at 141, whereas it is impossible to perform at touch at 131. The third reason is that a button press 1 132 requires effort of finding the button and pressing the button, the display screen has to be turned on 133, the GUI 134 screen determining and limiting the touch operation by its appearance, the GUI 134 which is programmed to several inputs can stop touch e.g. the pressing button 1, the GDE 135 is required to be touched to perform only the predetermined operation of the touch e.g. slider performs the unlock, and needs to be performed within a time limit of screen in activity but the user just needs to touch the screen to perform the touch operation 142 in FIG. 14 with none of these limits having all the benefits of claim 11 over the touch GUI. The user then has to waste a digit movement from the button press 1 132 to the screen which is a wasted and unnecessary movement compared to just touching the screen in 142. Thus in every way the WYSIWYG is inferior to the independent touch interface.

### FIG. 15

There is no near prior art for this invention as it is a new interface operating by a completely different operation in FIG. 14 compared to the nearest prior art touch interface of the '443 patent.

This is because this new independent touch interface is completely different from the prior art interface, in that it does not require a display screen to be turned on.

The command-line interface CLI required a display screen to be turned on to see a user typing one or more lines on the screen to operate the GUI. The GUI required a display screen to show a graphical display elements GDE 135 of a desktop blank screen, windows, icons and menus to be located by a pointing device and click to execute a command of the GDE.

The '443 patent is the nearest prior art patent which programmed the mobile phone screen perform all operations by contact and not pressing (without having to click) the screen. The '443 patent explained 4 steps to build an touch phone from the Apple Notepad (Beta Version—later named Newton Messagepad) to a touch mobile phone which operates by contact and not pressing the screen, from the description in the '443 Zeroclick Device.

701. Get Notepad. Column 79 lines 10-11. 702. Remove or deactivate resistive-touch screen and with a transparent touchpad programmed to perform an operation by touch instead of being used for resting the finger to point in the resistive touch screen GUI. Column 78 lines 6-12. 703. Enable the touchpad (original name for capacitive touch in May 2001 when filed) to be transparent to show the buttons on the LCD screen e.g. control area 1 as shown on FIG. 67. Column 78 line 36-42. 704. Make the screen size of the notepad to become the size of the FIG. 67 screen size to make a touch-sensitive screen phone Column 78 line 32-37. However, the LCD screen was needed to be turned on to show the control area 1 or GDE so the user could touch it in FIG. 67.

The '443 described an unlock screen FIG. 67 (called a start sequence) by which the touch could be arranged so that the screen would not be activated or unlocked unless a specific touch including a swipe as described in claim 1, or 6 of the '443 was done to unlock the screen. However, it could never claim to be a touch interface because it required the user to touch a displayed GUI 134 screen in FIG. 67 with a displayed GDE 135 e.g. Control area 1. Thus the nearest it may be described as with all the latest prior art devices or touch software, is a touch GUI. It required a user to touch a GDE 135 on the screen in order to perform an operation not touch without even the display screen being turned on which is the invention of FIG. 14.

1. A method to unlock and/or perform an operation of a device,
the device includes a touch-sensitive display without requiring another external input including a sleep/wake button on the device,
the method comprises the steps of
(i) performs the unlock and/or the operation by a powered touch component of the display detecting a touch of a predetermined movement of contact of one or more digits on the display; and
(ii) without requiring a display component of the display to be powered.

2. A method of claim 1, whereby a movement of a digit detected on the display includes one or more of a contact, a slide, a swipe, or a removal of a digit.

3. A method of claim 2, whereby the touch of the predetermined movement comprises the movement of the digit, or movements of the digit in series, or movements of digits in series or simultaneously, to perform the operation, including a user-defined operation of the device.

4. A method of claim 1, whereby the touch to unlock the device and/or perform the operation is performed on the display with no lock screen and with no visual feedback because the display component is not powered.

5. A method of claim 4, whereby a number or characters required to unlock the device and/or perform the operation are entered by the touch at a location, locations, or areas of the display with no visual feedback.

6. A method of claim 4, whereby characters or a number entered is an equivalent of a passcode of an iOS Device or Android Device or Windows Device or Blackberry Device, or a Kindle Device or a Fire Device or any equivalent device which displays the lock screen with a passcode required to be entered in order to unlock the device, except the number or characters are entered without any visual feedback because the display component of the device is not powered.

7. A method of claim 1, whereby the operation of a task of one or more operations is performed by the touch and includes the task being performed by a swipe of a digit on the display with one or more of the following steps:
a) the swipe reduces power consumption of the device by only being connectively coupled to another computer or device during the task;
b) turning on the display component of the display to show a list of operations of the task;
c) each operation of the task is represented as an item of a list or an item of a menu;
d) each operation represented as an item has one or more options represented as areas within the item and one option is selected if the digit slides within that area on the display;
e) each operation selected is undone by moving within the area of another option within the item;
f) one or more options of an item is undone by a backward direction movement on the display to a preceding item;
g) a specialized slide operation navigates to and/or selects one or more additional data elements for an item;
h) the task including unlocking the device, and/or turning on the display, and/or selecting of an option for each item of the list, and/or completing the task by performing the selected options of the list, and/or saving data to non-transitory memory and/or turning off the display and/or locking the device is performed by a slide of the digit on the display;
i) all operations of the task may be performed by the swipe, including if a list extends over several sequential graphical appearances of the touch-sensitive display, by the swipe moving downwards and upwards on the display in a forward direction to a subsequent item to access all items of the list; and/or
j) the task represented as a list over multiple display appearances may be completed by a series of swipes and/or taps.

8. A method of claim 7, whereby
the operation includes sending information between another communicatively connected computer either wirelessly or wired to download or upload data from another computer; and/or
the downloaded data is provided as a list of one or more listed items;
and/or the user selects one option out of multiple options for one or more multiple listed items to record data by a single swipe; and/or
multiple swipes; and/or taps; and/or
listed items are displayed on one or more multiple display appearances; and/or
saves the recorded data to non-transitory memory on, the other computer and/or the device; and/or
integrates the saved recorded data with, existing data on the other computer, and/or the device, and/or
the other computer sends further items deduced from one or more selected options of the task by the user, and/or
wherein the data is medical data, and/or
the downloaded data is listed medical record data from a patient's record, and/or
listed items to record for one or more presenting complaints of the patient, and/or
the other computer is a primary care computer, or a secondary care computer, or a regional or national computer population database, or the National Health Service NHS spine, or an organization patient database including an medical insurance patient database, and/or
the saved recorded data provides further management steps for the user to perform for the patient and/or
the task requires data, from a global positioning system GPS to perform the operation, and/or the task is a business task.

9. A method of claim 1 by which the user performs a task of one or more operations by one or more items of a list on a display of a computer communicatively coupled to a pointer movement input, including a digit or a stylus sliding on the touch-sensitive display as the pointer movement input, or a mouse movement as the pointer movement input, by the steps of the pointer movement according to a specific movement to
(i) optionally unlock the computer;
(ii) optionally turn on the display;
(iii) select an option for each item of the list;
(iv) optionally undo a selected option by moving the pointer to a preceding item;
(v) complete the task by performing the selected options of the list;
(vi) optionally save data to non-transitory memory;
(vii) optionally turn off the display;
(viii) optionally lock the device;
(ix) optionally display the pointer;
(x) optionally use a swipe or a tap on the touch-sensitive display or key press or other input to the computer to enable an alternative input to perform an operation of the task; and
(xi) optionally include one of the following;
a) select one or more options for each item of the list of items on the display by moving a pointer within an, option of an item to select the option by a forward pointer movement to a subsequent item,
b) the selection of the one or more options of the item is undone by a backward pointer movement to a preceding item,
c) the items may be more items than can be displayed on one display appearance, and may by moving in a forward downward direction of pointer movement select an option for each item including a bottom item on the display, and by moving the pointer below and past the bottom item on the display, display the next items on the display, which the user can continue to select an option for each item including the top item in a forward upward direction of pointer movement on the display, and by moving the pointer above and past the top item on the display, display the next items on the display, and so on, so the user is able to select an option for all items in the list,
d) when the selection of options for the list of items is completed by the forward pointer movement at least moving the pointer to an area past a last item, a processor connectively coupled to the display performs a completion operation of the task of the one or more operations determined by one or more selected options of the items,
e) pointer movement saves data of the task to non-transitory memory on the computer,
f) the pointer movement input includes a pointing device pointer movement, and/or the mouse pointer movement on the display, and/or the finger movement, and/or the stylus movement on the display with a touch-sensitive component,
g) the pointer movement input may only be the finger movement input on the touch-sensitive display completing any operation of the task by a slide operation on the display,
h) the finger movement may perform selection of an option or options of an item or items of the task, undoing a selected option or options of the task, undoing a completed the task, or completing a task by a tap or a swipe,
i) the data may be incorporated with other data by pointer movement,
j) based on the selection of options that comprise the task, further items may be deduced to be added to the list by the other data,
k) selection of options, undoing of options, and completing the task may use an alternative input than pointer movement to the computer,
l) the pointer may be visible or invisible on the display,
m) completion of the task records medical data of the selected options to a patients notes by pointer movement,
n) the operation of the task allows a navigation to more items on a further display of items by pointer movement,
o) the operation of the task provides further items and options for each further item to be added to the list of items by pointer movement,
p) the task is a business task,
q) the completion of the task by pointer movement is faster than any other input method to perform the task,
r) a central computer with multiple task menus completed by pointer movement can reduce user's time in data entry compared to a prior art pointing device method in the NHS, and
s) the operation of the task uploads and downloads information to the NHS spine or other central computer by pointer movement.

10. A method of claim 1, whereby a pointing device is performable by the touch, by a first digit touching the display as a pointing digit, and the second or further digit touching the display as a clicking digit, and the pointing digit points to the location to which the movement of the clicking digit on the display performs the operation, and
optionally the pointing, digit touching the display alone cannot perform the operation, and all digits of the hand touching the display may initiate the touch as the pointing device, and/or then lifting off all digits of the hand from the display may undo the operation, and/or may deactivate the pointing device of the touch; and
optionally the predetermined movement includes the second digit tapping on the display to the left of the pointing digit location on the display to perform the operation equivalent to a left mouse down, and/or mouse up and/or click at the pointing finger location on the display; and likewise the second digit tapping on the display to the right of the pointing digit location on the display performs the operation, equivalent to a right mouse down, and/or mouse up and/or mouse click, at the pointing digit location on the display, and the touch with a respective different predetermined movement optionally performs one or more respective different pointer device operations.

11. A method of claim 1, whereby the touch performing the operation, including the operation being a task of a sequence of operations, is improved compared to the operation in a sleep mode of a prior art performed by requiring the multistep process of another external input turning on an unpowered touch-sensitive display to display a lock screen in order to, perform the operation by a digit contacting the display in at least one of the following aspects:
a. the touch component of the display is powered for a longer duration to detect the touch than in the sleep mode in the prior art which taught the opposite teaching that the display should not be powered to save battery power and prevent something happening if you touched the display,
b. more instant,
c. more accessible,
d. quicker,
e. easier,
f. less power consumption,
g. more reliable as less components needed,
h. more economical as less components needed,
i. increased capacity as can perform operations without either another external input or a powered display component, and/or operations with another external input, and/or operations with the display component, powered,
j. less effort,
k. simpler,
l. safer in an accident with an internal button,
m. more user friendly as the user can define their own user defined operation or task,
n. simpler for a user and skilled person to design their own touch operation or operations,
o. less likely to lose a stylus as the stylus is attached to finger,
p. more aesthetic device surface appearance and/or with less buttons or switches on the surface of the device,
q. uses less digit movement or effort to perform the operation or a task of more than one operation than any other input method in the sleep mode in the prior art,
r. improves user intelligence by performing operations without visual feedback,
s. improves user recall of the user by performing operations without visual feedback,
t. improves decision making of the user by performing operations without visual feedback,
u. improves the performance of any prior art input method,
v. improves the security of information on the device, and
w. is fully backward compatible to perform the operation by any other input including a pointing device, a keyboard, a gyroscope, a light sensor, a proximity sensor, and a GPS.

12. A method of claim 10, whereby the pointing digit is identified by a pointing stylus attached to the pointing digit, and the second digit optionally is identified by a stylus attached to the second digit, and all operations may be prevented from being performed until the predetermined movement is performed, including the predetermined movement being the display detecting the second digit of a thumb touching the pointing digit of a forefinger causing the pointing digit to write as a pen on the display, and removing, the thumb from the forefinger stops the pointing digit writing, as a pen.

13. A method of claim 1, whereby power consumption of the touch component performing the operation is decreased compared to the power consumption of the touch-sensitive display in a prior art performing the operation, including one of the following:
a) the touch does not require the display component to be turned on and thereby decreases the power consumption of the touch-sensitive display performing the operation compared to the device in the prior art,
b) the touch component is divided into two or more areas, and in a lower powered mode only a smaller area than the whole touch component of the touch-sensitive display is powered,
c) a solar power cell or a series of solar power cells positioned within the area of the touch component of the display powers the touch component of the display,
d) the smaller area and/or solar power cell by a predetermined movement of a digit on the display turns on one or more further areas of the touch component to be powered to detect the touch to perform the operation,
e) the touch component has more than one circuit to the smaller area and/or solar power cell to enable the device to be reset if the screen is frozen, and/or provide two or more different electrical circuits to perform one or more operations of the device by the touch so the device is operable even if one circuit of the touch component is inoperable,
f) the touch component is a part of a surface of the device, or the touch component is one surface of the device, or the touch component may extend to another surface of the device,
g) the display component occupies less area on the surface of the device than the touch component of the touch-sensitive display, but the display component may occupy the same surface area as the touch component,
h) the circuits enables the touch to perform the operation at any time while the device is powered with a reliability greater than a single circuit of the touch component, and
i) enables the touch to be the only required user input of the device.

14. A method of claim 1, wherein the device is a watch, and/or a watch face is the touch component, of the display, and/or the touch is performed on the watch face with the display component turned off and/or on, and/or the display component is a transparent LCD display under the watch face, and/or the watch face is transparent, and/or the watch is an analog watch, and/or the watch is a Swiss watch.

15. A method of claim 1, whereby a processor further detects and is communicatively coupled to an input in a prior art, including one of the following; a pointing device, or a keyboard, or a force applied of the digit to the display, and/or to perform an operation by the input according to the method in the prior art.

16. A method of claim 1, wherein the device in a prior art includes the device communicatively connected to the touch-sensitive display, and the device in the prior art includes a state of the display being unpowered, and thus incapable of both detecting contact of a digit on an unpowered touch component of the display and incapable of displaying anything on a unpowered display component of the display, including one of the following:
(i) the operation is any operation of the device in the prior art, including unlocking, or any other operation on the device which becomes available after being unlocked;
(ii) the operation turns the device to silent when vibrating or emitting a sound by the touch on the touch-sensitive display;
(iii) the device performs the operation by only the touch on the touch-sensitive display at any time while the device is powered, whereas this is impossible for the device in the prior art in a sleep state as the touch-sensitive display is unpowered;
(iv) battery power is conserved better by having an always on touch component to perform the operation by the touch than in the device in the prior art which required a powered display component to perform the operation;
(v) the touch to perform the operation to turn on the display component is less likely to be accidentally triggered by the user than pressing an external, mechanical button on the device in the prior art;
(vi) the touch performing the operation is a safer and/or more reliable method of keeping information secure within the device than in the prior art;
(vii) the touch component being always on enables the user to perform the operation by the touch on the touch component alone and by a faster method than the device in the prior art performing the operation in a sleep state;
(viii) the touch performing the operation is an easier method than, the device in the prior art in a sleep state performing the operation;
(ix) the ability to reset an inoperative touch component is performed by an internal button or switch, or by a separate additional electrical circuit to the touch component, or by one or more light sensors within the touch-sensitive display;
(x) a user's memory is improved by performing the operation as the user performs the operation by the touch on a display with no visual feedback of the display component;
(xi) the touch performs the operation of undoing the operation;
(xii) the touch performs the operation in less steps than the device in the prior art in a sleep state;
(xiii) digit, movements on the touch component of the display is less than the digit movements on the device in the prior art in a sleep state to perform the operation, including the operation being a task of one or more operations;
(xiv) an appearance of the device compared to the device in the prior art is different;
(xv) the device performs the operation without requiring one or more of the following prior art dependencies: an external button press, the display component to be turned on, a graphical appearance displayed on the display component, a graphical element displayed on the display component, and a time dependency to turn off the display component if the touch-sensitive display is not touched;
(xvi) one or more external buttons or inputs in the device in the prior art are not required on the surface of the device, including one or more of the following:
a) power on or off button, b) a home button, c) a volume up and down button, d) a headphone socket, e) a computer lead socket, f) the sleep/wake button and g) a power socket; and
(xvii)
the operation is a Global Positioning System coordinate sent by signal from the device, including to an emergency service, and/or a text message and/or dial a predetermined number, by one of the following: (a) an internal button or switch to perform the operation, and/or to reset the device, and/or to disconnect a power of a battery from the device, and (b) the touch to perform the operation by a separate circuit to the touch component and/or a circuit of solar power cells within the touch or display components of the display surface area on the device.

17. A method of claim 1 of unlocking the device by the predetermined movement including a first swipe on the display with the display component of the display not powered until the first swipe is completed, and thereafter a desktop is displayed on the display, and a further predetermined movement, including pressing a displayed button on the desktop without needing the display to be sensitive to a degree of force to the display, performs the operation, and the further predetermined movement of the finger causes one of the following:
(i) moves the displayed desktop in a selected direction by a swipe;
(ii) performs the operation to display an Internet browser by the button press;
(iii) performs the operation to display a multimedia player or a multimedia recorder by the button press;
(iv) performs the operation to dial a phone number on the device, including a mobile phone or a touch-sensitive pad, by the button press;
(v) performs the operation to display a menu by the button press;
(vi) performs the operation to open and display any other application by the button press;
(vii) performs the operation to text including a mobile phone or a touch-sensitive pad or a watch or other device with the display, and
(viii) the further predetermined movement including a second swipe on the display turns off the display component and locks the device until the first swipe is performed.

18. A non-transitory computer readable medium for a device, the device including a touch-sensitive display, and the computer readable medium storing computer executable instructions that, when executed by a processor, causes the processor to perform an unlock and/or perform an operation of the device by the following steps:
(i) performs the unlock and/or the operation by a powered touch component of the display detecting a touch of a predetermined movement of contact of one or more digits on the display;
(ii) without requiring another external input including a sleep/wake button on the device; and
(iii) without requiring a display component of the display to be powered.

19. A device comprising a touch-sensitive display communicatively coupled to a processor communicatively coupled to memory storing instructions that, when executed by the processor, cause the processor to unlock and/or perform an operation of the device, and
performs the unlock and/or the operation by a powered touch component of the display detecting a touch of a predetermined movement of, contact of one or more digits on the display, and
without requiring another external input including a sleep/wake button on the device, and
without requiring a display component of the display to be powered.

20. The device of claim 19 is one of the following:
(i) a mobile phone,
(ii) a touch-sensitive pad,
(iii) a multimedia player,
(iv) a camera or video recorder,
(v) a watch, including an analog watch,
(vi) a control panel for a vehicle including a boat, plane, or car,
(vii) a desktop computer communicatively coupled to a desktop touch-sensitive display,
(viii) a laptop computer communicatively coupled to the touch-sensitive display,
(ix) a piece of jewelry communicatively coupled to the touch-sensitive display,
(x) a mobile device that is button-less, and
(xi) a mobile device, wherein the touch determines the operation, not the visual feedback of the display determining the operation of the touch.
